(19) United States
(12) Patent Application Publication
(10) Pub. No.: US 2010/0289270 A1
(43) Pub. Date: Nov. 18, 2010

(54) PYROLYTIC THERMAL CONVERSION SYSTEM

(75) Inventors: Scott Behrens, Noblesville, IN (US); Brian Rayles, Indianapolis, IN (US); Robert E. Burrows, III, Indianapolis, IN (US)

Correspondence Address: TAFT, STETTINIUS & HOLLISTER LLP, SUITE 1800, 425 WALNUT STREET, CINCINNATI, OH, 45202-3957, US

(73) Assignee: Organic Power Solutions, LLC, Indianapolis, IN (US)

(21) Appl. No.: 12/778,903

(22) Filed: May 12, 2010

Related U.S. Application Data
(60) Provisional application No. 61/177,356, filed on May 12, 2009.

(51) Int. Cl. C10B 47/44; C10B 7/10; H02K 7/18

(52) U.S. Cl. 290/1 A; 201/1; 202/117; 202/118

(57) ABSTRACT

A pyrolytic process includes converting various organic wastes into more readily usable organic substances such as, without limitation, organic gases and liquids that may be used as fuels. An exemplary pyrolytic process generates sufficient organic fuels in satisfaction of the heat requirements and electrical requirements to carry out the pyrolytic process, thereby providing excess fuels above and beyond those necessary to carry out the process.

### CROSS-REFERENCE TO RELATED APPLICATIONS

This application claims priority to U.S. Provisional Patent Application Ser. No. 61/177,356 filed on May 12, 2009, entitled, “Special Pyrolytic Thermal Conversion System,” the entire disclosure of which is incorporated herein by reference.

### FIELD OF THE INVENTION

The present disclosure relates generally to process equipment and associated methods for carrying out pyrolysis processes in order to decompose organic materials into gases, liquids, and solids.

### RELATED ART

“Pyrolysis” refers to a process by which organic materials are decomposed into solid, gas, and liquid components, without combustion or oxidization. Pyrolysis processes are utilized in order to obtain usable materials from waste products while avoiding production of unnecessary oxygen compounds and polluting materials. In addition, pyrolysis processes are utilized to reduce the space occupied by organic waste as the decomposed liquid and solid products from pyrolysis typically occupy less space.

Pyrolysis processes involve the pyrolytic conversion of carbon containing (i.e., organic) materials to hydrocarbon products at temperatures above 800° F. (430° C.). At these temperatures, some of the hydrocarbon products may spontaneously combust in the presence of sufficient oxygen. In order to reduce the oxygen content in a pyrolysis process, which would otherwise lead to combustion, undesirable products and side effects, it is important that the organic waste feed materials be fed to a pyrolysis reactor without introducing significant ambient air or other high oxygen streams. One conventional method to address the amount of oxygen reaching the interior of a pyrolysis reactor includes implementing air locks when the organic waste feed stream is fed to the pyrolysis reactor.

### INTRODUCTION TO THE INVENTION

The instant disclosure provides a pyrolytic process to convert various organic wastes into more readily usable organic fuels (e.g., hydrocarbon fuels). This exemplary pyrolytic process takes various organic wastes as a feed stream and applies heat to the wastes in order to decompose the wastes into combustible gas, liquid, and solid products that include, without limitation, oil, diesel-like fuel, char, combustible gases, and pyrogas/syngas. These combustible products may then be used, in part, to generate heat necessary within the pyrolytic reactor to break down incoming organic waste streams. In addition, these combustible products may be used as fuels for additional processes such as, without limitation, the generation of electricity from a generator coupled to a combustion engine. Moreover, the solids exiting the pyrolytic process may be used as organic fertilizers, fuel, or as a carbon source for industrial products.

The exemplary pyrolysis process incorporates many novel and nonobvious aspects, such as utilization of exhaust gases as purging gases to come into contact with the feed organic wastes to drive off oxygen and inhibit in the influx of ambient air or another oxygen rich fluid stream into the pyrolysis reactor. In addition or alternatively, exhaust gases from electricity generation processes (combustion engine exhaust gases) may be utilized to provide at least a portion of the heat required for the decomposition reaction within the pyrolysis reactor.

In exemplary form, the pyrolysis process equipment includes: (1) an organic waste feedstock collection device; (2) a pre-reaction conditioning and delivery device; (3) a single or multiple stage pyrolysis reactor; (4) a reactor off-gas treatment and separator system; and, (5) a reaction solids collection and extraction device.

The exemplary pyrolysis process may be utilized to provide an environmentally friendly alternative to incineration because of integrated emissions controls, production of organic fuels, and the absence of appreciable combustion. Exemplary integrated emissions controls may include utilization of thermal oxidizer technology or catalytic controls. The exemplary pyrolysis process may be utilized to reduce the volume of the organic waste feed materials by 75-90 percent, where the product gas generated has a higher BTU value than comparable gasification technologies. In addition, the exemplary pyrolysis process may be utilized to destroy pollutants in the organic waste feed and generate liquid products comprising oils and fuels similar to diesel.

Exemplary organic waste feed materials include, without limitation, automotive shredder residue (ASR), municipal solid waste (MSW), animal waste from concentrated animal feeding operations (CAFO's), sewage sludge, plant food waste sludge and solid materials, animal manure, recycled and non-recyclable plastics, used tires, fabrics and carpets, paints, animal carcasses, paper and wood products, plant stalks (corn, wheat, soy beans, etc.), and a variety of other organic wastes.

Some exemplary advantages that may be present or result from using one or more of the exemplary embodiments described herein include, without limitation: (1) modularized design providing lower capital costs and allowing the system to be readily installed and operational; (2) design of auger and auger housing comprising part of the pyrolytic reactor provides for improved life-cycle and reduced system maintenance; (3) continuous pyrolytic process reduces operator workloads and increases system capacity and energy efficiencies, in part by reducing start-up energy; (4) continuous pyrolytic process creates a continuous input and output; (5) fully automated system eliminates the need for full time operators; (6) capable of processing moisture content feed stocks up to 70% moisture; (7) system design allows for process heat to be provided by shell (e.g., tube) exterior sources, internal shell sources, or a combination of internal and exterior sources; (8) no requirement for special sand or fluidized bed equipment; (9) systems can be “banked” for large capacity needs; (10) equipment is integrated into a small footprint for indoor or outdoor installations; (11) reduced operating costs; and, (12) reduced waste volume. It should be noted that the foregoing is not an exhaustive listing of potential exemplary advantages and those skilled in the art following the description provided herein may well realize other advantages that will have no bearing on the scope of the invention.

By way of introduction, an exemplary pyrolytic process in accordance with the instant disclosure includes feeding an organic waste through an optional preprocessing process and then onto a pyrolytic reactor. Within the pyrolytic reactor, the organic waste is agitated and exposed to elevated temperatures within an oxygen depleted environment in order to decompose portions of the organic waste into a gaseous phase.

Presuming the pyrolytic reactor is carrying out a continuous process, as opposed to a batch process, organic waste is constantly or at least periodically added to the reactor. The rate of addition of the organic waste may depend upon the size of the reactor, the composition of the organic waste, and the moisture content of the organic waste, just to name a few factors. In order to accommodate various organic wastes whose composition may change while carrying out a continuous process, the pyrolytic reactor may include at least one auger to progressively move the organic waste through the reactor, while concurrently agitating the waste. To ensure that the organic waste reaching the end of the reactor is sufficiently decomposed, the resident time may be adjusted as the composition of the organic waste entering the reactor changes.

The exemplary pyrolytic process makes use of a master controller that monitors certain conditions related to the operation of the pyrolytic reactor and other equipment downstream or otherwise associated with the overall process, as well as the contents flowing through process conduits in order to make real-time adjustments to compensate for changes in composition of the organic matter fed to the pyrolytic reactor. In a continuous process, where the pyrolytic reactor includes at least one auger, the rate of rotation of the auger conveying the organic waste within the pyrolytic reactor is used to modify the resident time.

Simply put, the resident time within the pyrolytic reactor for a given organic waste will change as the composition and moisture levels of the organic waste change. For example, an organic waste having a relatively high moisture content will require a longer resident time than the same or a similar organic waste having a lower moisture content. And certain organic wastes (e.g., old tires) require longer resident times than other organic wastes (e.g., recycled paper).

Within the pyrolytic reactor, the gas phase that results from decomposition and boiling of the decomposed substances is diverted away from the remaining solids and directed to a purification and separation process. In one exemplary embodiment, an eductor venturi scrubber operates on recycled process water at high-pressure and an adjustable flow rate to cool the gas stream to below the condensation temperature of entrained liquids and clean the gas of particulates. Thereafter, the output from the scrubber is a mixed phase of gas and liquid, which is sent to a separation tank to create three separate output streams. The first stream comprises purified gas, the second stream comprises a non-polar liquid (e.g., a hydrocarbon) and a third stream comprises a mixture of a polar liquid (e.g., water) and insoluble solids. These output streams may be directed to storage vessels or further downstream processes.

By way of example, the gas output stream from the separation tank may be utilized to provide a fuel source for a combustion device (e.g., a gas burner) associated with the pyrolytic reactor in order to provide at least a portion of the heat required. In addition or alternatively, the gas output stream may be directed to a combustion engine where the gas is combusted to turn an output shaft operatively coupled to an electric generator to produce electricity. It should be noted that the exhaust from the combustion engine may be directed to the pyrolytic reactor to provide a portion of the heat required to decompose the organic waste. In this manner, the pyrolytic process is capable of being self-sufficient from an electrical source and/or a heat source perspective because the pyrolytic process may generate decomposed products that provide energy sources above and beyond those necessary to operate the pyrolytic process.

### BRIEF DESCRIPTION OF THE DRAWINGS

FIG. 1 is a simplified schematic diagram of a first exemplary pyrolytic process in accordance with the instant disclosure.

FIG. 2 is a more detailed schematic diagram of the first exemplary pyrolytic process of FIG. 1.

FIG. 3 is elevated perspective view of an exemplary housing and manifold structure that may be used at part of the pyrolytic reactor of FIGS. 1 and 2.

FIG. 4 is cross-sectional view of the exemplary housing and manifold structure of FIG. 3, taken longitudinally.

FIG. 5 is an end view of an exemplary housing and manifold structure of FIG. 3.

FIG. 6 is an end view of an exemplary housing and shafted auger of FIG. 3.

FIG. 7 is a disjoined profile view of the exemplary housing and shafted auger of FIG. 4, with a portion of the housing removed to reveal the auger.

FIG. 8 is a bell-shaped curve representative of an exemplary production of combustible gases resulting from a pyrolysis reaction as a function of time.

FIG. 9 is elevated perspective view of portions of the hardware for use with the first exemplary pyrolytic process of FIG. 1.

FIG. 10 is elevated perspective view of portions of the hardware for use with the first exemplary pyrolytic process of FIG. 1 where electricity is generated and exhaust from the electric generation process is used to heat the pyrolytic reactor.

FIG. 11 is a schematic diagram of a first exemplary pyrolytic process of FIG. 2, shown with certain controller input devices and output devices.

FIG. 12 is a schematic control diagram showing exemplary inputs and outputs to a master controller as it relates to processes occurring within a continuous pyrolytic reactor and an upstream airlock for the organic waste feed stream.

FIG. 13 is a schematic control diagram showing exemplary inputs and outputs to a master controller as it relates to processes for scrubbing the desired gaseous byproducts from the pyrolysis reactor, as well as separating the gaseous byproducts into polar liquid, non-polar liquid, and gaseous streams.

FIG. 13 is a schematic control diagram showing exemplary inputs and outputs to a master controller as it relates to processes for recycling water from a separation unit for use again as a liquid for scrubbing the desired gaseous byproducts from the pyrolysis reactor.

FIG. 15 is a schematic control diagram showing exemplary inputs and outputs to a master controller as it relates to processes for utilizing the purified combustible gases output from the separation unit as fuels for a generator, fuels fed into a gas grid pipeline, fuels fed to a buffer tank, and fuels fed to the pyrolytic reactor for combustion to provide a heat source.

FIG. 16 is a partial control diagram of an overall process control for use with the instant disclosure, showing the master controller and an initial feed stage subroutine.

FIG. 17 is a partial control diagram of an overall process control for use with the instant disclosure, showing an airlock subroutine and a subsequent feed stage subroutine, both subroutines occurring subsequent to the initial feed stage subroutine of FIG. 16.

FIG. 18 is a partial control diagram of an overall process control for use with the instant disclosure, showing a reactor subroutine and a scrubber subroutine, both subroutines occurring subsequent to the second feed stage subroutine of FIG. 17.

FIG. 19 is a partial control diagram of an overall process control for use with the instant disclosure, showing a syngas/pyrogas subroutine occurring subsequent to the scrubber subroutine of FIG. 18.

FIG. 20 is a more detailed control diagram of the initial feed stage subroutine of FIG. 16.

FIG. 21 is a more detailed control diagram of the airlock subroutine of FIG. 17.

FIG. 22 is a more detailed control diagram of the subsequent feed stage subroutine of FIG. 17.

FIG. 23 is a more detailed control diagram of the reactor subroutine of FIG. 18.

FIG. 24 is a more detailed control diagram of the scrubber subroutine of FIG. 18.

FIG. 25 is a more detailed control diagram of the syngas/pyrogas subroutine of FIG. 19.

### DETAILED DESCRIPTION

The exemplary embodiments of the present disclosure are described and illustrated below to encompass organic waste processing devices and associated methods and, more particularly, to pyrolysis systems and processes for operating and controlling such systems. Of course, it will be apparent to those of ordinary skill in the art that the embodiments discussed below are exemplary in nature and may be reconfigured without departing from the scope and spirit of the present invention. However, for clarity and precision, the exemplary embodiments as discussed below may include optional steps, methods, and features that one of ordinary skill should recognize as not being a requisite to fall within the scope of the present invention.

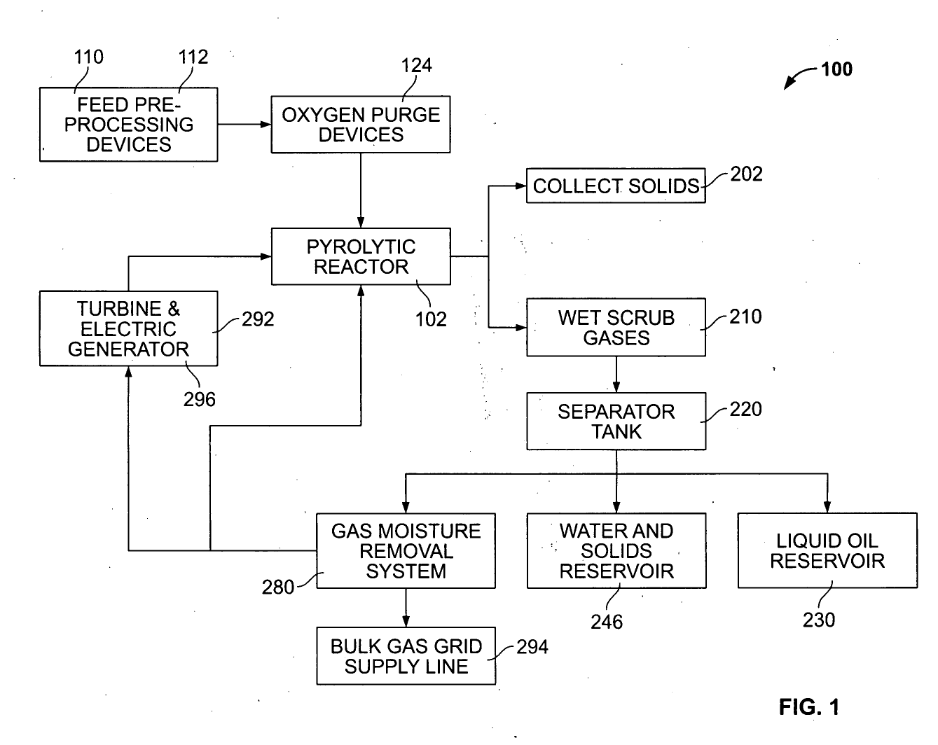

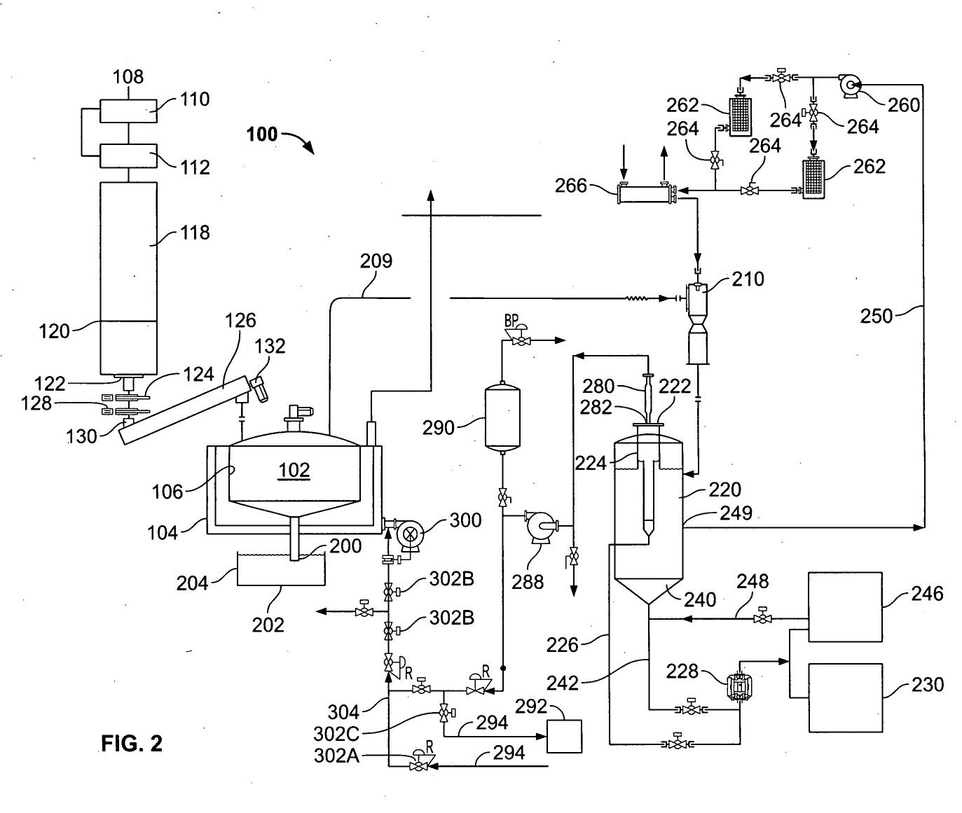

Referring to FIGS. 1 and 2, an exemplary continuous pyrolysis process 100 utilizes several unit operations to transform organic waste materials (hereafter, “feedstock”) 108 into various resultant products that may include, without limitation, oil, char, diesel-like fuel, and combustible gases such as pyrogas or syngas. Exemplary feedstocks may include, without limitation, one or more of the following: sewage sludge, old tires, landfill trash, automotive shredder residue (ASR), municipal solid waste (MSW), animal waste from concentrated animal feeding operations (CAFO's), plant food waste sludge and solid materials, animal manure, recycled and non-recyclable plastics, fabrics and carpets, paints, animal carcasses, paper and wood products, plant stalks (corn, wheat, soy beans, etc.), and a variety of other organic wastes. It should be noted that the exemplary continuous process 100 may be adapted to be used as a batch process.

Pyrolysis is generally defined as the chemical decomposition of organic materials at relatively high temperatures, most commonly in the absence of oxygen or in a reduced oxygen environment. Simply put, pyrolysis is not combustion and does not predominantly form combustion products, though some of the products are combustible. Rather, pyrolysis causes organic materials to decompose and create more readily combustible products. One of the advantages of pyrolysis is the conversion of organic materials into more basic combustible products, such as organic gases and organic liquids, which are compacted for ready storage in preexisting fuel storage containers, such as natural gas tanks and vehicle fuel (e.e., gasoline, diesel, etc.) tanks. In addition, pyrolysis is also operative to decompose certain non-environmentally friendly organic compounds into more simplistic and combustible products.

As will be discussed hereafter, some or all of the combustible products generated as a result of the pyrolytic process can be used to generate the necessary heat input to facilitate the organic material decomposition. In addition, excess combustible products generated from pyrolysis can be readily stored or delivered into existing conduits for dissemination via preexisting grids, such as natural gas pipelines.

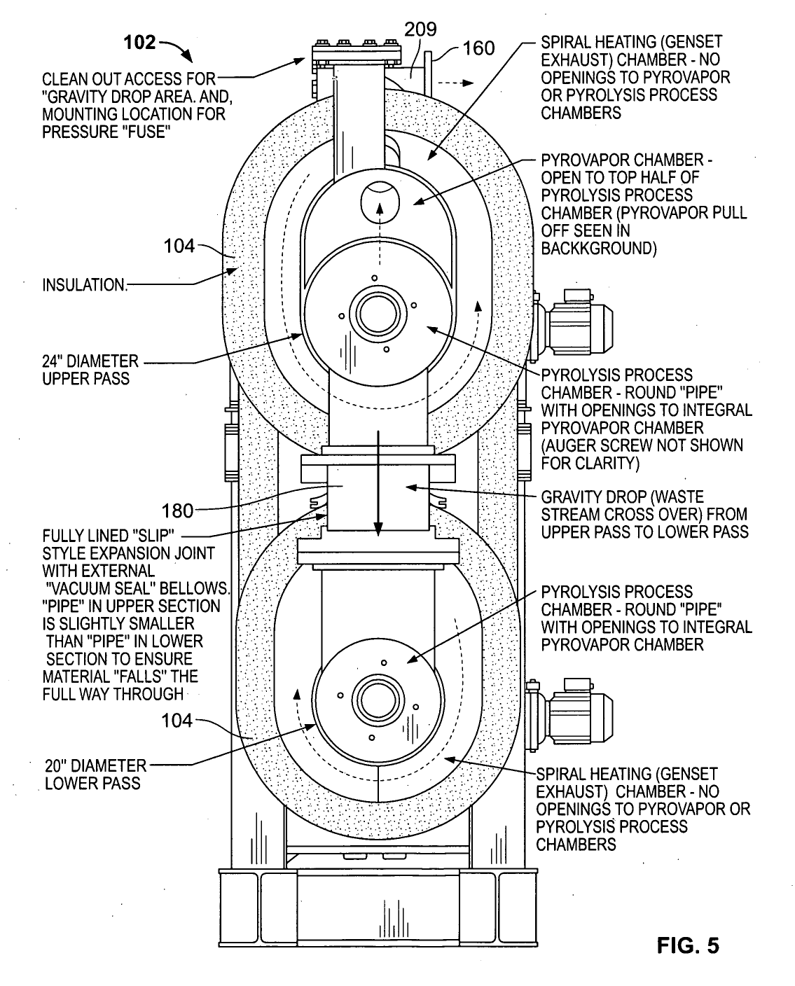

Referring to FIGS. 2-5, a first exemplary pyrolysis process 100 includes a pyrolytic reactor 102 having a thermal energy jacket 104 to inhibit fluid communication, within the reactor, of the heat source with the organic contents undergoing pyrolysis. In this exemplary embodiment, the pyrolytic reactor 102 utilizes a gas fired burner and/or exhaust from a combustion engine 106 to provide the heat source for the pyrolysis reaction. But before an organic feedstock 108 can undergo pyrolysis within the reactor 102, the feedstock may need to be conditioned.

Referencing FIG. 2, conditioning of the organic feedstock 108 may include subjecting the feedstock to a preheat process. The preheat process may utilize catalysts, common dryers, centrifuges, and the like to remove excess moisture and include catalysts or other additives to improve the decomposition of the feedstock 108 when within the pyrolytic reactor 102.

Conditioning of the feedstock 108 may also include verifying that the debris size of the feedstock does not exceed what the pyrolytic reactor 102 and associated hardware can accommodate. By way of example, the mean debris size for the pyrolytic reactor 102 ranges between 2-5 inches. To accomplish or verify the correct mean debris size, the exemplary process 100 may include an industrial shredder 110, such as a quad four shaft shredder or other shredder available from Shredding Systems, Inc. (www.ssiworld.com), which processes the organic waste material in order to verify or achieve debris sizes sufficiently reduced for introduction to the pyrolytic reactor 102. Alternatively, or in addition, the process 100 may include an industrial sifter 112 that is downstream from the shredder 110 to verify that the contents exiting the shredder are in fact of the proper debris size. Exemplary industrial sifters include the DH2 series vibrating screeners available from Smico Manufacturing (www.smico.com). Any feedstock 108 debris sizes larger than a predetermined maximum from the sifter 112 are returned to the shredder 110 for further processing. After the feedstock 108 debris size is within an acceptable range, the feedstock is directed into a pre-reaction processing operation.

The exemplary pre-reaction processing operation includes directing the feedstock 108, which includes organic and possibly some inorganic components, from a debris hopper 118 (downstream from the sifter 112) and into communication with a first light beam sensor 120. This first light beam sensor 120 acts as a safeguard to ensure no aspect of the feedstock 108 is too large so as to inhibit a gate valve 122 at the base of the hopper 118 from closing. In this exemplary embodiment, the gate valve 122 is a ten inch valve. However, valves larger and smaller than ten inches may be utilized depending upon the debris sizes of the feedstock 108.

Feedstock 108 exiting the hopper 118 is directed into an airlock 124 that interposes the hopper and an intake of a shaft-less auger 126. The airlock 124 is purged with exhaust gases from the gas fired burner of the pyrolytic reactor 102 or a combustion engine 106 in order to reduce or eliminate the diatomic oxygen content of the feedstock 108. Consequently, feedstock 108 exiting the airlock 124 and entering the intake of the shaft-less auger 126 has a diatomic oxygen content that is substantially less than atmospheric air. But before the feedstock 108 can enter the intake, the feedstock 108 passes through another ten inch gate valve 128 and another light beam sensor 130 operative to monitor the flow rate of feedstock 108 exiting the airlock 124. The ten inch gate valve 128 is operative to selectively isolate the airlock 124 from the chamber housing the shaft-less auger 126. This is particularly advantageous in cases where the exhaust gas purge is not functioning properly, or where the feedstock 108 entering the airlock 124 is too large for input to the shaft-less auger 126.

By using a shaft-less auger 126, the feedstock 108 sizes that the auger can transport to the pyrolytic reactor 102 are substantially greater than a shafted auger. While the feedstock 108 is transported along the length of the auger 126, the contents of the auger may be under vacuum in order to further purge any entrained diatomic oxygen. And a motor 132 used to rotate the shaft-less auger 126 is isolated from the chamber housing the shaft-less auger by mechanical, sealed bushings. At the end of the auger 126, opposite the intake, the contents are output to the pyrolytic reactor 102.

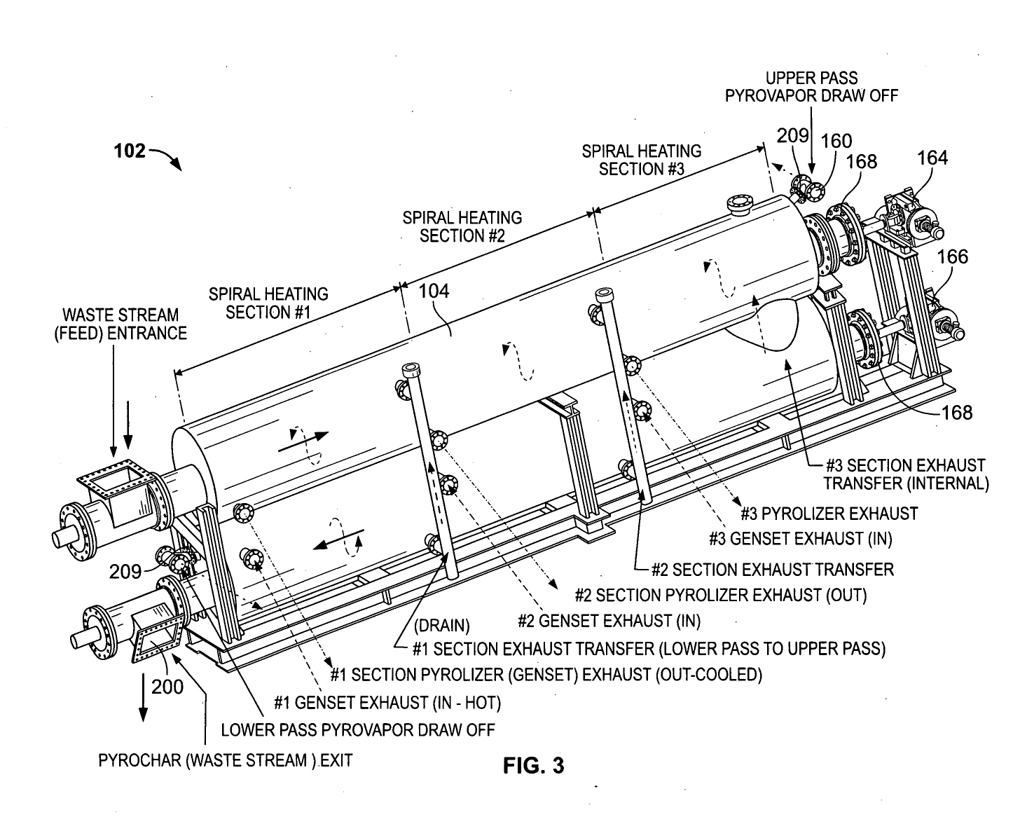

Referencing FIG. 3, an exemplary pyrolytic reactor 102 includes a twin screw 150, 152 arrangement. Each screw 150, 152 is encapsulated within a cylindrical housing 154 having a manifold 156 that communications with the interior of each housing at distributed points along the length of the screw 150, 152. In this manner, as gases are produced within the cylindrical housings 154 as a result of decomposition of the organic feedstock, the gases are collected and consolidated into a pair of off-gas outlets 158, 160.

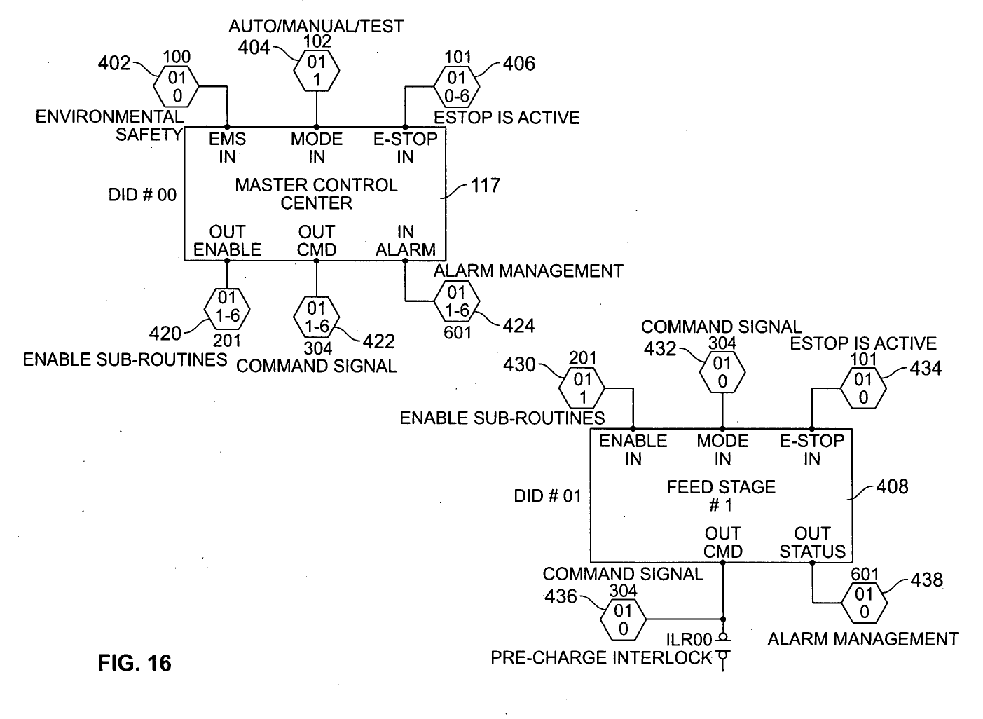

The first and second screws 150, 152 each include a shafted screw that is driven by respective variable speed motors 164, 166. The variable speed motors 164, 166 are operative to rotate the screws 150, 152, thereby moving the organic feedstock 108 longitudinally along the length of each screw. In exemplary form, the speed of rotation of the screws 150, 152 is controlled by a master controller 170 (see FIG. 16) and depends, at least in part, upon the temperature within the reactor 102 and the constituency of the organic feedstock 108. To obtain the required resident times in the reactor 102, the shafted screws 150, 152 turn relatively slowly (1-3 RPM).

In this exemplary embodiment, the rate of organic feedstock 108 input to the pyrolytic reactor 102 is partially dependent upon how quickly the decomposition of organic feedstock occurs within the reactor, which is based in part upon having sufficient resident time to allow the organic feedstock to decompose. In other words, materials (such as woodchips) that decompose more quickly and at lower temperatures allow for higher organic feedstock 108 rates (lbs/hr) and lower resident times, whereas materials (such as old tires) that decompose more slowly and at higher temperatures result in relatively lower organic feedstock addition rates and higher resident times. Those skilled in the art will also realize that larger diameter screws 150, 152 and/or longer length screws typically allow for higher organic feedstock rates, whereas comparatively smaller diameter screws 150, 152 and/or smaller length screws typically allow for lower organic feedstock rates.

Obviously, once the screw size has been selected, built, and installed, the size of the screw and the length of the screw are no longer variables. What is left as variables are the temperature within the reactor 102, the rotation rate of the screws 150, 152, and the composition of the organic feedstock 108. As will be discussed in more detail hereafter, the controller 170 monitors and controls temperature within the reactor 102 and the rotation rate of the screws 150, 152 to adjust for the composition (i.e., rate of decomposition) of the organic feedstock 108. In this exemplary embodiment, the diameter of the screws 150, 152 is 1/15 of the longitudinal length of the screws 150, 152. By way of example, a screw 150, 152 having a longitudinal length of 15 feet and has a diameter of 1 foot.

Referring back to FIGS. 3-5, the screws 150, 152 are horizontally offset and vertically spaced apart. This allows the top screw 150 to be individually rotated with respect to the bottom screw 152. Rotation of both screws 150, 152 is operative to mix the feedstock 108 within the reactor 102 to facilitate more uniform decomposition.

Each screw 150, 152 is mounted to respective electric motor 164, 166 that is isolated from the interior of the cylindrical housings 154 circumscribing the screws 150, 152 using seals 168. A sealed chute 180 links the end of the first screw 150 with the entrance of the second screw 152 in order to move solid material that exists at the end of the first screw to the second screw to continue the decomposition process until reaching exit of the second screw.

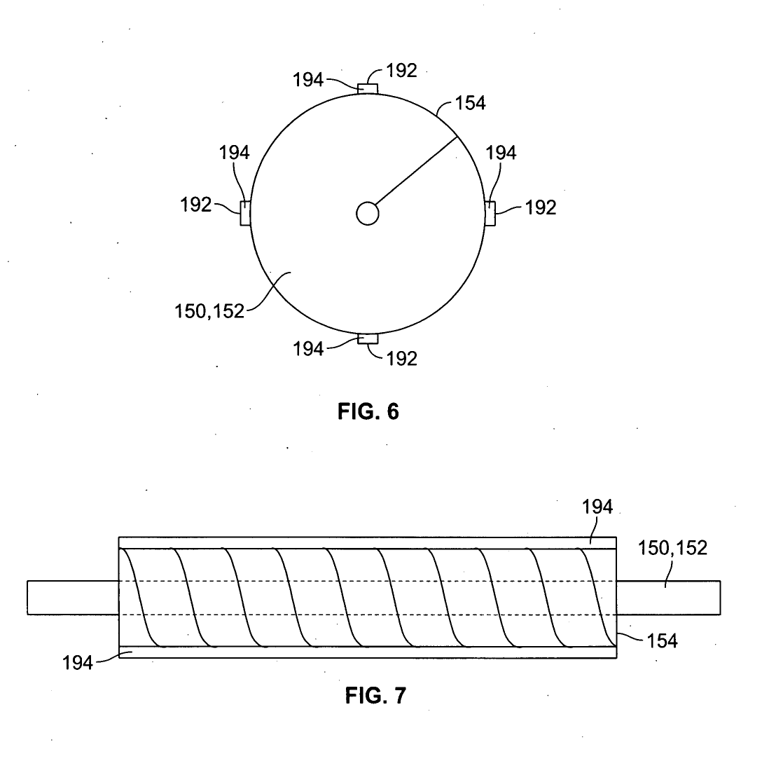

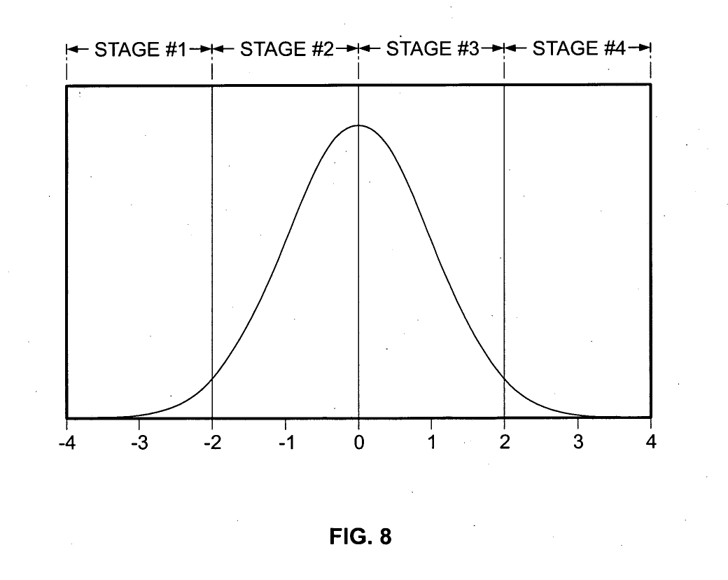

Referencing FIGS. 6 and 7, generally cylindrical housings 154 circumscribe the screws 150, 152 and include four longitudinal sleeves 192 extending substantially the entire longitudinal length of the screws that are each adapted to receive four flights 194. It should be noted that more or less than four flights 194 may be utilized for each screw 150, 152. The flights 194 act as bearing surfaces for the screws 150, 152 and are inset with respect to the interior wall of the housing 154 to extend farther into the interior of the screws 150, 152. In this exemplary embodiment, the flights 194 are fabricated from bronze, which is a material less durable than the shafted screws, which are fabricated from a high temperature alloy such as, without limitation, stainless steel, in order to decrease wear on the screws 150, 152 and the cylindrical housings 154. When the flights 194 have been worn so that the interior surface is substantially flush with the interior surface of the cylindrical housing 154, the flights are removed and replaced. Additionally, the use of a cylindrical housing allows for the rotation of the screws 150, 152 to move along the flight surfaces and thereby extend the useful life of the housing 154.

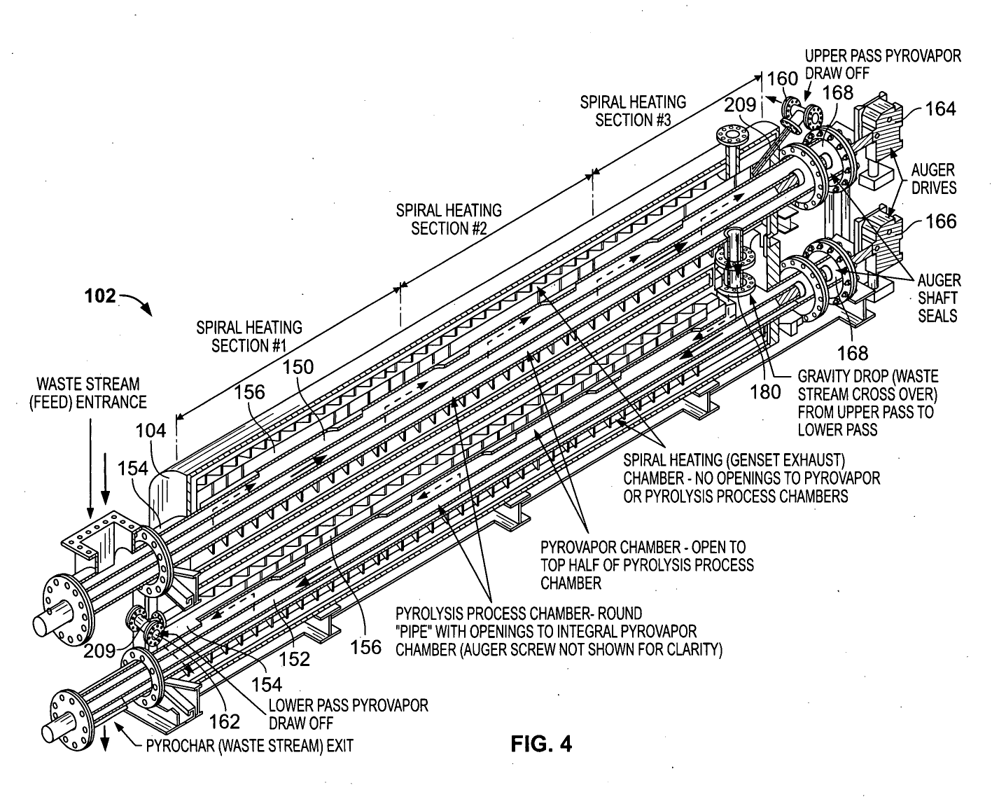

Referring back to FIGS. 3 and 4, the pyrolytic reactor 102 includes generally four stages. The precise location of the stages within reactor 102 changes with the composition of the organic feedstock. For example, relatively wet sewage sludge as the organic feedstock will have different stage locations within the reactor 102 in comparison to an organic feedstock comprising low moisture woodchips or tires, for instance.

By way of explanation, the first stage comprises a drying stage where water is driven off as part of the vapor phase. As will be discussed in more detail hereafter, the gas produced during this first stage is primarily water, which is scrubbed and removed by a downstream scrubber. After the drying stage is the second stage, an initial gas production stage, in which the most volatile organics vaporize to produce a combustible gas. Again, as will be discussed in more detail hereafter, the combustible gas produced during this second stage is cooled and scrubbed by a downstream scrubber. The third stage, a bulk gas production stage, is where relatively moderate to low volatile organics vaporize to produce a concentrated combustible gas. Similar to the second stage, the combustible gas from this third stage is cooled and scrubbed to purify the combustible gas. Finally, the fourth stage, a final processing stage, is the stage where relatively lower value combustible gas is produced from those organics that are last to decompose and solid char is discharged from the reactor 102 at the end of the second screw 152.

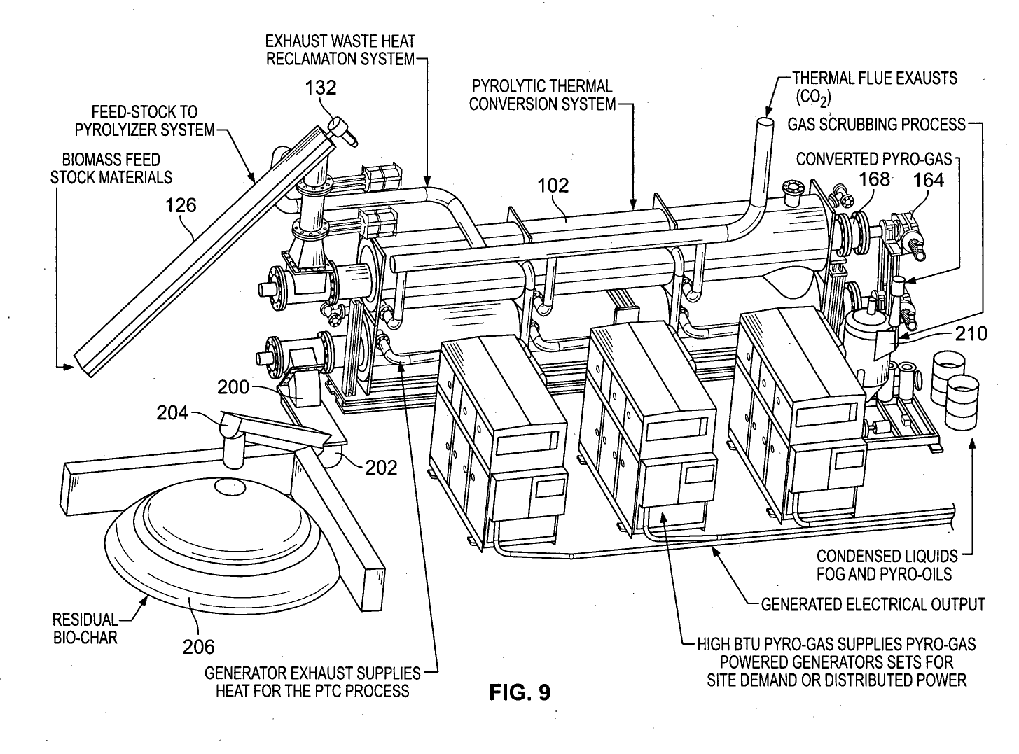

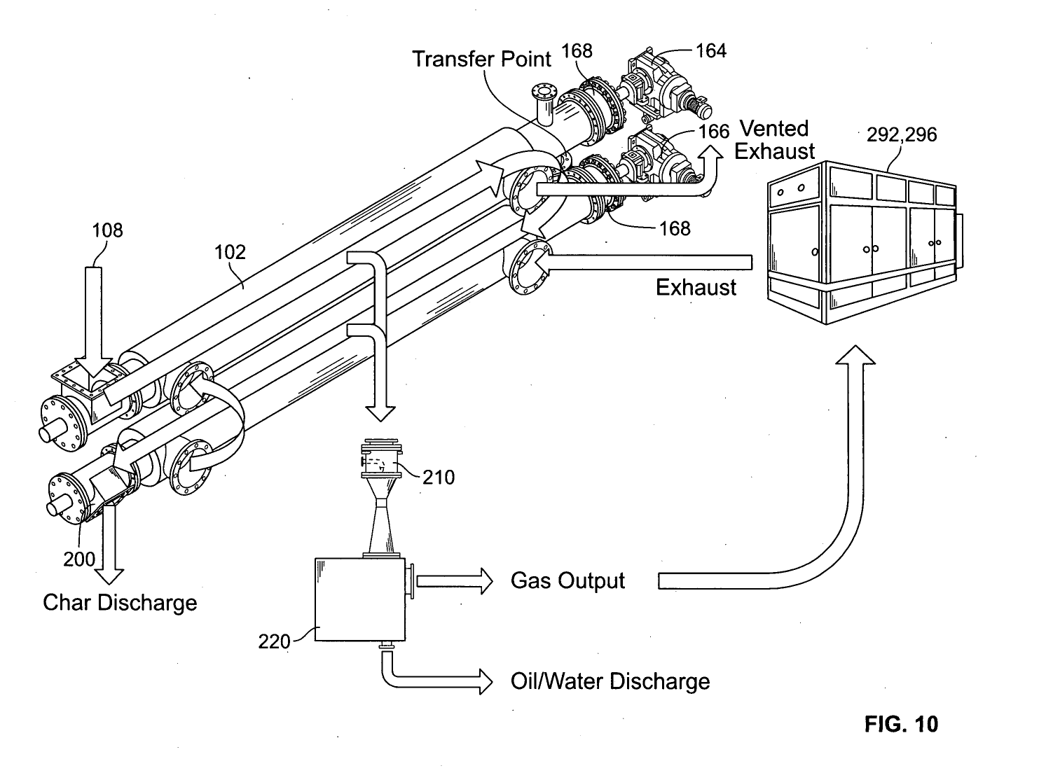

Referring to FIG. 8, a bell curve represents the gas production over time for a given input of organic feedstock. In general, for a given feedstock, the heat capacity (BTU value) of the combustible gas produced will increase and then decrease over time. In a four stage system, the first and fourth stages produce relatively lower value combustible gas, whereas the second and third stages are operative to produce a relatively high value combustible gas. This exemplary bell curve is for purposes of generalized explanation only and those skilled in the art will understand that such a curve would vary depending upon the organic feedstock utilized and the resident time of the feedstock within the reactor 102. For example, certain organic feedstocks, such as recycled paper, are operative to create valuable combustible gases very early on in the pyrolysis reactor 102 and would not closely approximate the curve of FIG. 8.

Referring back to FIGS. 2 and 3, in order to maintain a back end air lock at the exit of the second screw 152, the second screw includes a chute 200 that is partially submerged within a liquid bath 202 to create a liquid lock. The liquid lock operates to inhibit gaseous communication between atmospheric air and the interior of the second screw 152, thereby inhibiting an influx of oxygen that might otherwise result in combustion reactions as opposed to pyrolysis decomposition reactions. In this exemplary embodiment, the liquid bath 202 comprises a relatively low vapor pressure liquid that is operative to cool the char (i.e., the solids that exit the pyrolysis reactor 102) that exits from the second screw 152 by way of the chute 200. By way of example, this relatively low vapor pressure liquid may comprise water.

The liquid bath 202 may include a partially submerged auger 204 to remove cooled char from the bath. It should also be noted that the cooled char may be manually removed from the liquid bath 202 and deposited in a char pile 206, or the liquid bath may comprise a batch operation that is replaced when the bath becomes filled with cooled char. Though not necessary, a reserve liquid reservoir (not shown) may also accompany the liquid bath 202 to supply additional liquid to the bath 202 to compensate for liquid that has vaporized while cooling the char. Those skilled in the art will realize that any vaporized bath liquid will either condense and fall back into the bath or be removed as part of the vapor phase from the reactor 102.

As discussed above, the organic feedstock (i.e., organic debris) 108 can comprise a generally uniform material (such as wood chips or sewage sludge) or may comprise various materials (such as landfill trash) that include inorganics, such as metals and glass. Those skilled in the art will understand that the metals and other non-organics that are fed to the pyrolytic reactor 102 will most likely not decompose further or vaporize. Instead, any metals or glass within the organic feedstock 108 predominantly leave the reactor as part of the solids/char exiting the reactor 102 through the chute 200.

Referring again to FIG. 3, the gases produced during the pyrolysis reaction are drawn away from the screws 150, 152 by way of the manifolds 156 because of the reduced pressure exhibited within the manifolds that draw the gases into a pair of discharge pipes 209. One or both of the discharge pipes 209 may include a motorized auger (not shown) in order to remove viscous liquids and solids that build up within an interior of the pipes. Both discharge pipes 209 are in communication with the inlet of a Venturi wet scrubber 210.

Referencing FIG. 2, the Venturi wet scrubber 210 includes high pressure liquid nozzles that direct scrubbing liquid into a converging section located above the Venturi throat. This introduction of a high pressure scrubbing liquid creates a pressure drop that effectively pulls the gases and other contents (i.e., viscous liquids and displaced solids) from within the discharge pipes 209 in the direction of scrubbing liquid flow toward the Venturi throat. What exits the scrubber 210 is single outlet stream that includes a gas phase and a liquid phase (may also include entrained solids within the liquid phase) that are directed to a bulk separation tank 220.

It is preferred that the wet scrubber 210 be located within close proximity to the reactor 102 to ensure that the gas phase of the combustibles is maintained. Exemplary distances falling within close proximity include, without limitation, twenty feet or less (e.g., ten feet). If the proximity is not close, the discharge pipe 209 may be heated and/or insulated in order to maintain the temperature of the combustibles so as to retard significant liquid and solid buildup on the interior of the discharge pipes 209. As discussed previously, the discharge pipes 209 may include mechanical scrapers such as augers to clean the interior surfaces of the discharge pipes of viscous liquids and deposited solids.

Referencing FIGS. 1 and 2, the bulk separation tank 220 is operative to separate the gas phase from the liquid phase, and thereafter separate the liquid phase into polar and non-polar liquids. Initially, the bulk separation tank 220 includes a liquid phase comprising a non-polar liquid (e.g., oil) above a polar liquid (e.g., water). The outlet stream from the scrubber 210 is introduced below the level of the non-polar liquid within the separation tank 220 so that the non-polar liquid within the scrubber outlet stream floats on top of the polar liquid within the tank, while the gases from the outlet stream of the scrubber 210 are bubbled through part of the polar liquid and essentially all of the non-polar liquid in the separation tank. This bubbling of the combustible gases through part of the polar liquid and essentially all of the non-polar liquid is a second form of cleansing before the combustible gases exit the top of the separation tank 220 via a gaseous outlet 222. Because the outlet stream of the scrubber 210 also includes polar and non-polar liquids and solids, the levels of polar and non-polar liquids within the separation tank 220 are continuously managed by the master controller 170.

In this exemplary embodiment, the interior of the separation tank 220 includes a non-polar liquid collection drain 224 to withdraw non-polar liquid from the separation tank as the level of non-polar liquid within the tank rises and overflows into the drain. The level of non-polar liquid within the separation tank 220 is caused to rise primarily based upon the addition of non-polar liquid to the tank via the outlet stream from the scrubber 210. The collection drain 224 occupies a fixed location and is recessed far enough beneath the gaseous outlet 222 so that non-polar liquid is not drawn out of the separation tank 220 through the gaseous outlet. The base of the drain 224 connects to a discharge pipe 226 that exits the separation tank 220 and thereby conveys non-polar liquid that enters the drain out of the tank and into communication with a pump 228 that delivers the non-polar liquid to a storage reservoir 230. It should be noted that the bubbling action of the gases (from scrubber 210), teamed with the flotation of the non-polar liquid above the polar liquid cleans the non-polar liquid and reduces particulate matter in the non-polar liquid stream that exits the separation tank 220. The majority of the particulate matter that finds its way into the gaseous stream exiting the pyrolytic reactor 102 is eventually removed at the bottom of the separation tank 220.

The bottom of the separation tank 220 is conically shaped in order to funnel the particulate matter within the tank toward the bottoms outlet 240. This bottoms outlet 240 is submerged in the polar liquid and flows into a discharge pipe communicating with the pump 228 to draw off a combination of the polar liquid and particulate matter from the bottom of the separation tank 220 to a holding reservoir 246. In addition, the fresh water pipe 248 may also provide water to the separation tank 220 as needed. It should be noted that the separation tank 220 includes an outlet 249 for water from the tank to enter a recycle water loop 250 responsible for providing filtered, cool water to the scrubber 210. This outlet 249 is positioned above the conical bottom of the separation tank 220 in order to reduce the amount of particulate matter entering the recycle water loop 250.

In this exemplary embodiment, the recycle water loop 250 draws off water from the separation tank 220 using a water pump 260 and routes water through one or more particulate filters 262. Depending upon the amount of water flowing through the recycle water loop 250 and the capacity of the particulate filters 262, one or more particulate filters may be utilized. In this case, two particulate filters 262 are provided with associated control valves 264 downstream from the pump 260 so that when one particulate filter is not in use, such as during regular maintenance, the second particulate filter is capable of handling the entire filtering load. As will be discussed in more detail below, the master controller 170 receives pressure readings from the particulate filters 262 and automatically adjusts the flow rates between the filters based upon differential pressure readings. Alternatively, both particulate filters 262 can be used at the same time. Regardless of which particulate filter(s) is used, filtered water exits the filters and is directed into a heat exchanger 266.

The heat exchanger 266 is utilized to decrease the temperature of the water that exits the filter(s) 262 and prepare a cool water stream for entry into the scrubber 210. In this exemplary recycle water loop 250, the water entering the heat exchanger 266 is preferably dropped in temperature below 85 degrees Fahrenheit for entry into the scrubber 210. This drop in temperature can be accomplished using various heat exchangers 266, but in exemplary form the heat exchanger comprises a shell and tube heat exchanger.

The combustible gases from the pyrolysis reactor 102 that enter the separation tank 220 are withdrawn from the top of the tank and fed into a moisture removal system 280 that comprises a demister and may optionally include a dehumidifier. Before the gases enter the moisture removal system 280, the gases pass a thermocouple 282 that provides a temperature reading to the master controller 170. In order to draw off the gases from the top of the separation tank 220 and through the moisture removal system 280, a blower 288 (downstream from the moisture removal system) creates a lower pressure on the inlet side (scrubber 210 side) and a higher pressure on the outlet side of the blower. The outlet side of the blower 288 is operative to direct combustible gases to one of a plurality of destinations that include a gas buffer tank 290, a generator 292, a natural gas grid connection 294, and supplying combustible gas to the gas fired burner 106 of the pyrolytic reactor 102. As will be discussed in more detail hereafter, depending upon the amount of combustible gas generated as a result of the pyrolytic decomposition reactions, some or all of the combustible gas may be utilized to fire the gas burner 106, with any excess combustible gas being distributed to the gas buffer tank 290, the generator 292, and/or the natural gas grid connection 294.

During start-up of the pyrolytic process 100, it is necessary to utilize a heat source apart from the combustible gases that will be eventually produced from the decomposition reactions occurring within the pyrolysis reactor 102. In this exemplary embodiment, the start-up heat source is natural gas supplied from the natural gas grid connection 294. However, other sources of heat may be utilized such as oil-fired burners, char combustion, and superheated steam. Those skilled in the art will understand that various heat sources may be utilized and supplemented to provide the requisite heat source for the pyrolytic reactor 102.

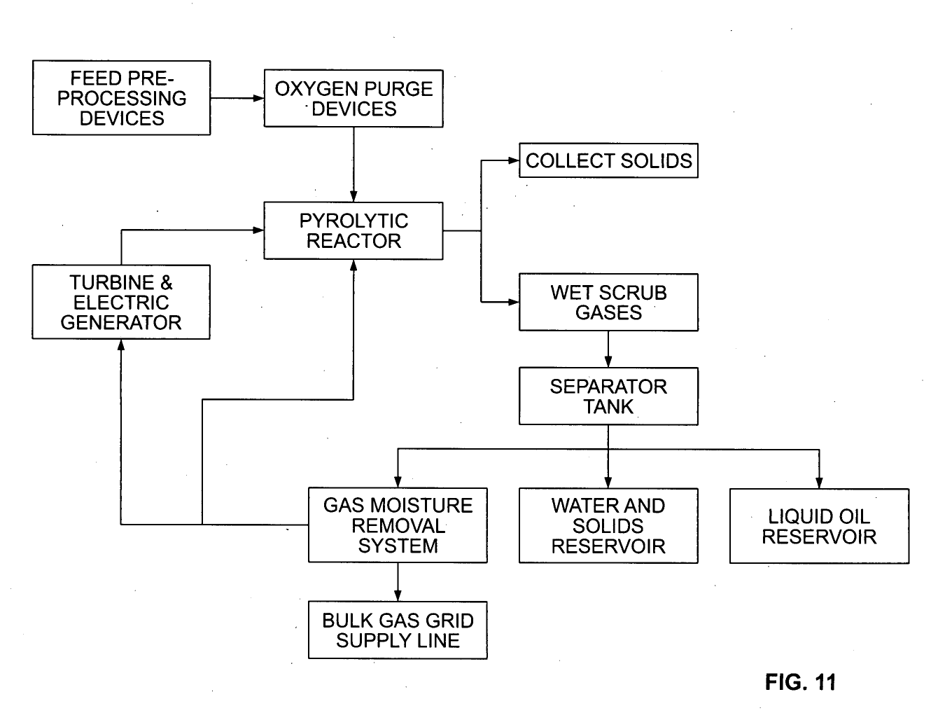

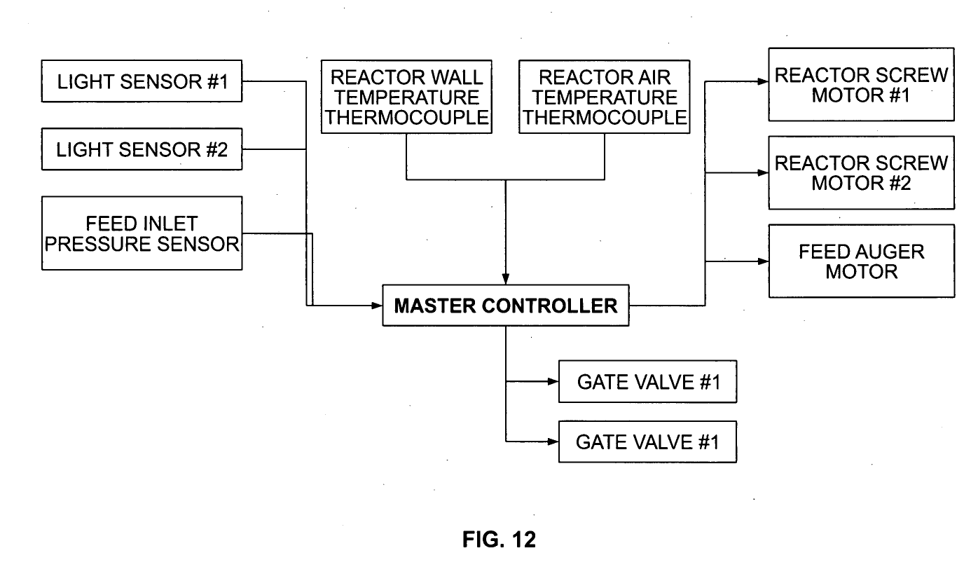

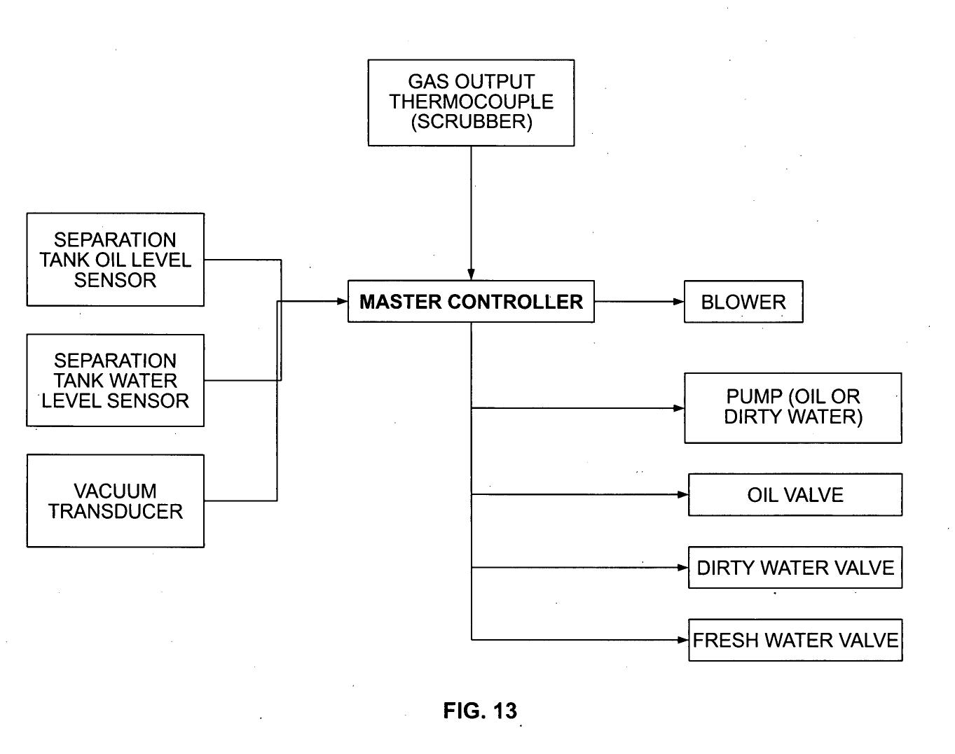

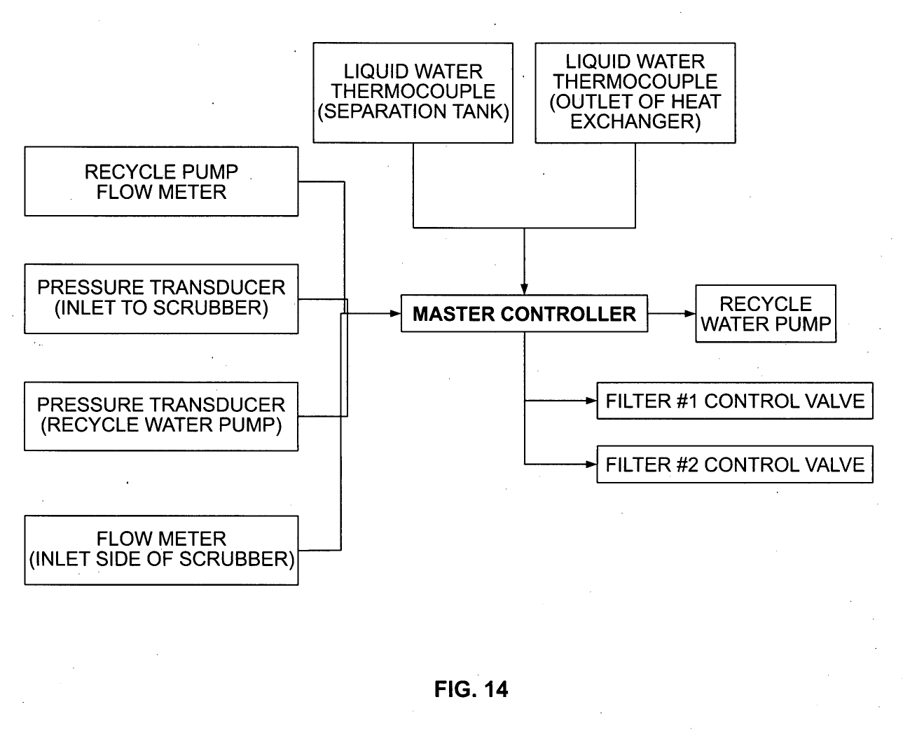

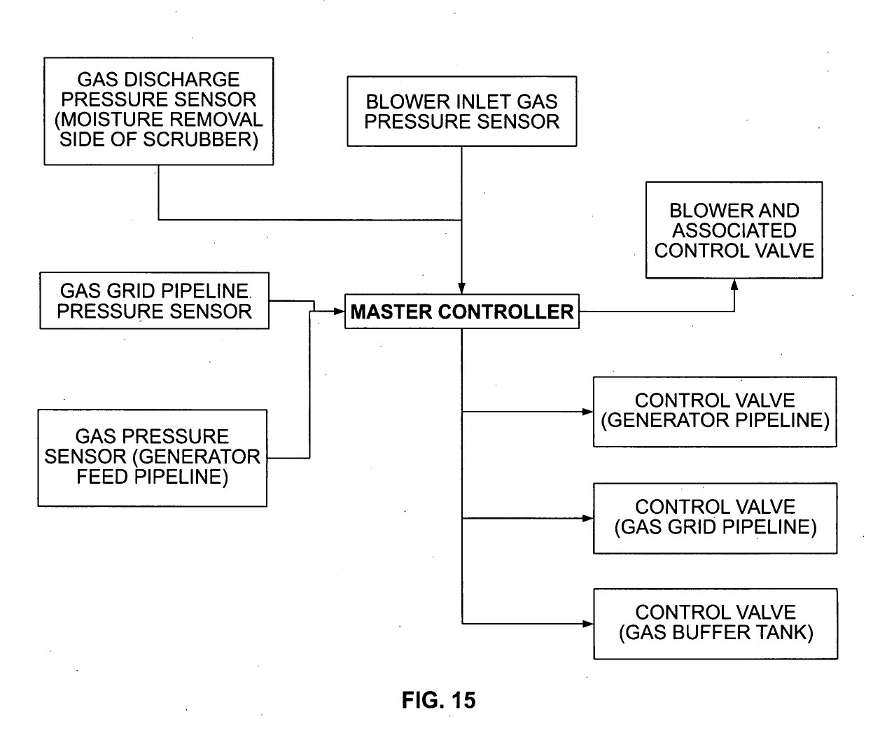

Referring to FIGS. 1, 2, and 10, when excess combustible gases are generated via the pyrolytic decomposition reactions, and these combustible gases are more than enough to supply the heat source requirement (i.e., enough gas for the burners 106), the excess gases may be combusted by a combustion engine 296 (e.g., a turbine engine) that is coupled to an electric generator 292. Those skilled in the art are familiar with gas turbine engines integrated with electric generators to generate electricity. Moreover, the waste heat from the combustion engine 296 may be routed to a steam unit (not shown) where steam is produced to turn the same or a different electric generator 292. Alternatively, or in addition, the waste heat from the combustion engine 296 may be routed to through the pyrolysis reactor 102 to provide at least a portion of the required heat load.

In exemplary form, after the pyrolytic process 100 produces combustible gases in sufficient quantity to at least partially supply the requisite heat source requirement for the pyrolytic reactor 102, these gases are directed to the burners 106 within the reactor 102 via a make-up blower 300. A series of control valves 302 and pressure sensors 304 provide feedback to the master controller 170 about the pressure of combustible gases available for burning within the reactor 102, or being available to be fed to the combustion engine 296, or available to be fed directly into the natural gas supply line 294. Ideally, after a predetermined time, the pyrolytic process 100 is operative to generate enough combustible gases to concurrently satisfy the heat source requirements of the reactor 102 and provide excess gases for electricity production via the generator 292 and/or additional natural gas back into the gas.

It should also be noted that the pyrolytic process 100 has electricity requirements such as those necessary to drive the pumps 228, 260, 288, 300 and for the motors 164, 166 that turn the screws 150, 152. In exemplary form, after the pyrolytic process 100 has been operational for a predetermined time and operative to generate combustible gases in excess of those utilized to supply the requisite heat to the reactor 102, the excess combustible gases are combusted in the combustion engine 296 that is operatively coupled to the generator 292 in order to produce and supply the electricity necessary to operate the process equipment. By way of example, an exemplary pyrolytic process operating for approximately 2 hours may be operative to generate in real-time enough combustible gases to ultimately supply the requisite heat source requirement when combusted by the burners 106 within the reactor 102. At the same time, excess combustible gases may be routed to the combustion engine 296, with the exhaust from one or more of these engines being used in place of the burner 106 exhaust to heat the pyrolytic reactor 102.

Referring to FIG. 16, the master controller 170 receives a number of inputs from various distributed sensors that provide the master controller with real-time information as to current stance of portions the pyrolytic process 100. Using this information, the master controller 170 sends signals and instructions to various subcontrollers associated with respective equipment in order to make adjustments to the overall process 100. Generally, the master controller 170 may comprise a digital computer functioning as a programmable logic controller (PLC). For purposes of explanation only, the master controller 170 will be described with respect to certain distinct sub-processes that comprise parts of the overall process in order to provide greater detail about the control structure.

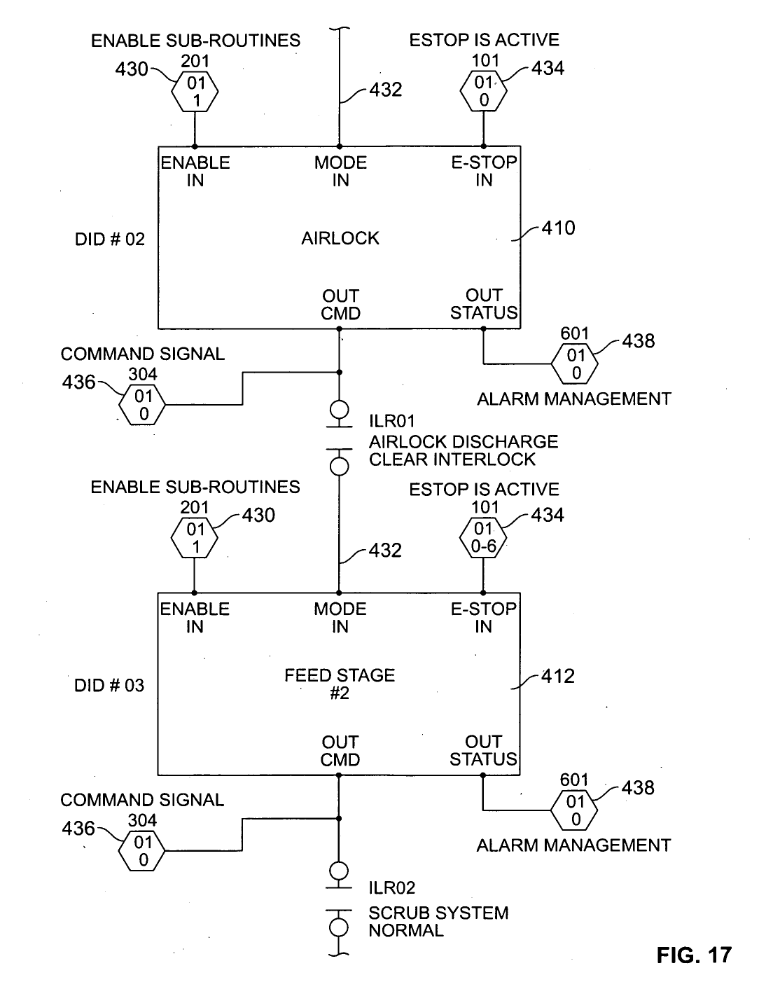

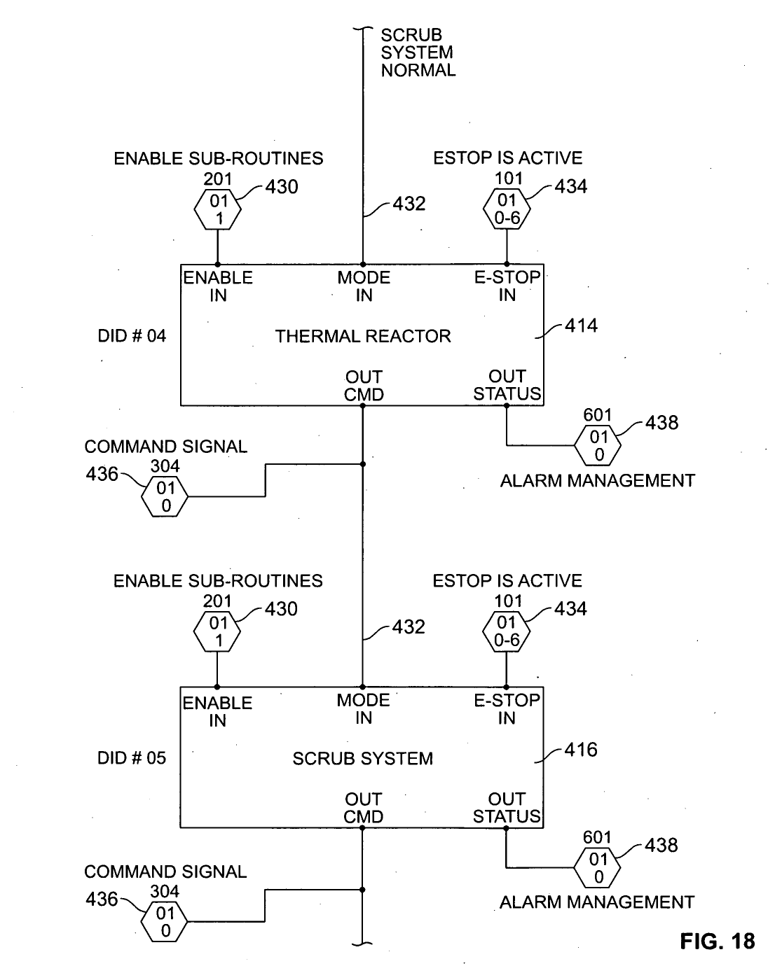

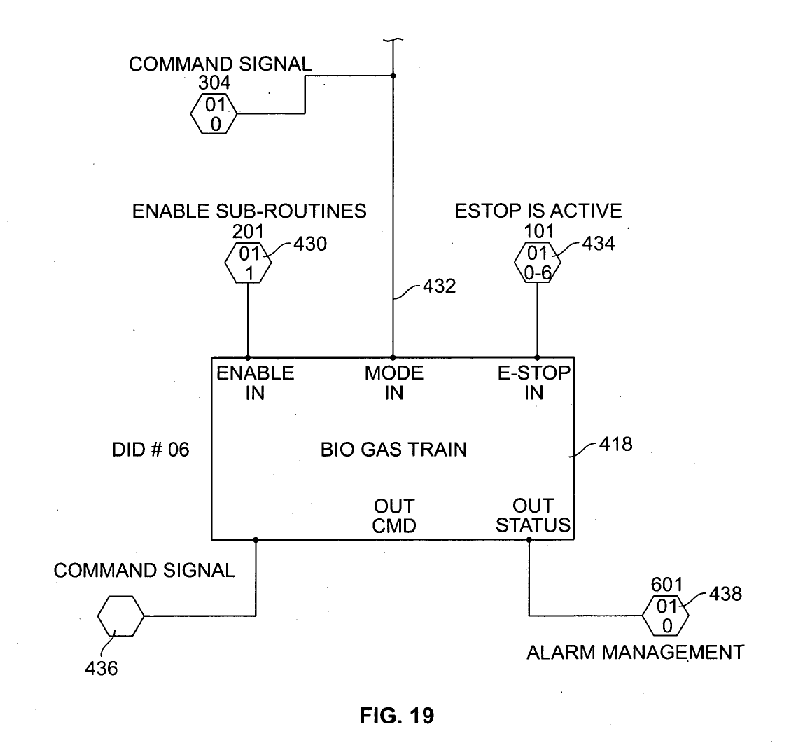

Referencing FIGS. 16-19, the master controller 170 includes a number of inputs 402, 404, 406 in addition to the inputs received from the respective subroutines 408, 410, 412, 414, 416, 418 as part of controlling the overall pyrolysis process 100. The first input 402 comes from fire suppression equipment (not shown) distributed throughout the process 100. This input 402 indicates to the controller whether any of the fire suppression equipment is inoperable, whether any of the fire suppression equipment has been deployed and not reset, and whether any of the fire suppression equipment is currently being used. The second input 404 comes from a human operator selecting the mode of operation for the process 100. In exemplary form, there are three modes of operation: (1) automated; (2) manual; and, (3) test. As the first mode of operation, automated functionality does not require human intervention beyond starting the process 100. Manual mode operates the system in automated mode, but allows a human operator to manually change one or more of the equipment settings. While the controller 170 is in manual mode, the safeguard remain in place so that a human operator cannot manually change one or more of the equipment settings that would result in a hazardous or destructive circumstance. In exemplary form, while in manual mode, the human operator may increase the rate of rotation of the first auger 150 within the pyrolytic reactor 102, but this would not be possible if the motor 166 turning the second auger 152 was either turned off or otherwise not operational. Finally, the test mode allows for automated or manual mode operation, but for a predetermined period of time, after which the process 100 is shut down. Finally, the third input 406 comes from a logic switch indicating that a manual process shutdown has not been tripped. As will be discussed in more detail below, if the manual process shutdown is tripped, one or more portions of the process 100 will be shut down to avoid injury to human bystanders/operators.

In addition to the inputs 402, 404, 406 received by the master controller 170, the master controller also provides outputs 420, 422, 424 to the respective subroutines 408, 410, 412, 414, 416, 418 in order to enable and command the subroutines, in addition to operating alarms that provide visual and/or audible indications to bystanders/operators that one or more aspects of the process 100 may require further manual attention or to warn bystanders/operators to stay clear of one or more pieces of equipment. In this exemplary embodiment, the first output 420 is operative to communicate with the subroutines 408, 410, 412, 414, 416, 418 and enable the subroutines at the proper time(s). The second output 422 sends command signals to the subroutines 408, 410, 412, 414, 416, 418 based upon the subroutines sending signals to the master controller 170 to carry out one or more process steps. Finally, the third output 424 may be to a control panel (not shown) or individual visual or audible devices associated with respective pieces of equipment in order to indicate that further manual attention is required or to warn bystanders/operators to stay clear of one or more pieces of equipment. Based upon the inputs from the subroutines 408, 410, 412, 414, 416, 418, the master controller 170 knows whether the third output 424 should be used to send a signal to a control panel (not shown) or individual visual or audible device.

In this exemplary embodiment, each of the subroutines 408, 410, 412, 414, 416, 418 comprise software and may be interrelated with one another. However, those skilled in the art will understand that the software may be supplemented or supplanted by application specific hardware. Each subroutine 408, 410, 412, 414, 416, 418 receives a number of general communications 430, 432, 434 from the master controller 170, as well as sending a number of general communications 436, 438 to the master controller. The first 430 of these general communications is a start process communication that instructs the subroutines 408, 410, 412, 414, 416, 418 to initialize there respective routines. The second general communication 432 is a control signal instructing each routine concerning its respective mode of operation between automatic, manual, or test. A third general communication 434 is a logic switch signal used to instruct the subroutines 408, 410, 412, 414, 416, 418 to carry out steps beyond initialization after the master controller 170 has received confirmation that the subroutines have successfully carried out a prefatory step. In order for the master controller 170 to know whether a requisite prefatory step has been completed by the subroutines 408, 410, 412, 414, 416, 418, each subroutine includes first general sent communication 436 that comprises a software interlock providing status information to the master controller. Exemplary status information includes, without limitation, the subroutine is on stand-by, the subroutine is currently carrying out a particular step, and the subroutine has completed a particular step. Finally, each subroutine 408, 410, 412, 414, 416, 418 also includes a second general sent communication 438 as to alarm conditions. By way of example, the second general sent communication 438 may indicate to the master controller 170 that: (1) all alarms are functional, but not signaling an alarm condition; (2) all alarms are functional, but one or more of the alarms is signaling an alarm condition; (3) less than all alarms are functional, but none of the functional alarms is signaling an alarm condition; and, (4) less than all alarms are functional, but one or more of the functional alarms is signaling an alarm condition. The master controller 170 monitors the subroutines 408, 410, 412, 414, 416, 418 and uses the sent communications 436, 438 to determine what command signals 422 are forwarded to the respective subroutines and optionally activate one or more alarms via the third output 424.

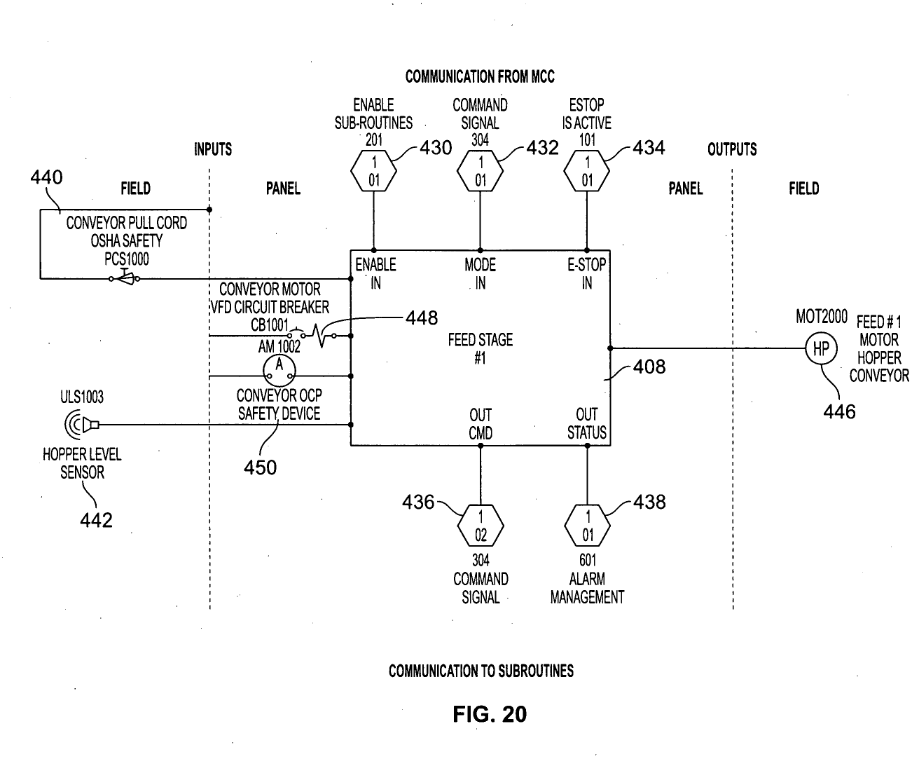

Referring to FIGS. 2 and 20, the first subroutine 408 controls the hardware utilized to bring the feedstock 108 from the hopper 118 and into communication with the gate valve 122. The first subroutine 408 receives communications from a manual safety stop cord 440 positioned proximate the discharge point from the hopper 118 to the gate valve 122. By way of example, an open auger (not shown) may be utilized to move feedstock 108 from the hopper 118 and through the gate valve 122. In such a circumstance, an open auger provides for the possibility that an operator or bystander could be pulled into the auger and unable to free oneself. In such a case, a manual safety stop cord 440, when pulled, sends a signal to the subroutine 408 indicating the equipment controlled by this subroutine should be immediately shut down. While not critical, the manual safety stop cord 440 may be manually reset or reset via the master controller 170. In addition to potentially receiving signals from the manual safety stop cord 440, the subroutine 408 also receives signals from a sensor 442 mounted within the hopper 118. In this manner, the subroutine can discontinue rotation of the auger to move the feedstock 108 into communication with the gate valve 122 when insufficient feedstock is present within the hopper 118. Moreover, the status of the feedstock 108 within the hopper 118 directly affects the subroutine sending command signals 446 to the motor (not shown) turning the open auger and directing feedstock 108 into communication with the gate valve 122. This subroutine 408 also includes an associated circuit breaker 448 and a current monitor 450.

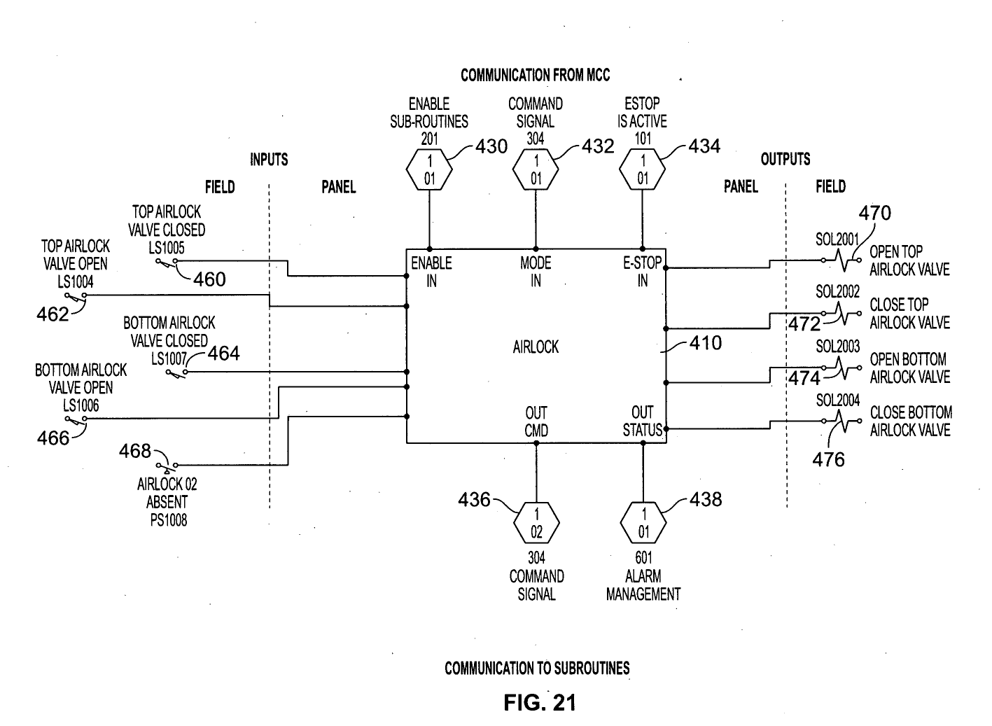

Referring to FIGS. 2 and 21, the second subroutine 410 controls the hardware utilized proximate the airlock 124 to bring the feedstock 108 from the gate valve 122 and into communication with the shaft-less auger 126. The second subroutine 410 receives communication signals 460, 462 from sensors (not shown) associated with the first gate valve 122 and communication signals 464, 466 from sensors (not shown) associated with the second gate valve 128, as well as communication signals 468 from a vacuum sensor (not shown). The first communication signal 460 tells the subroutine 410 if the first gate valve 122 is open, whereas the second communication signal 462 tells the subroutine 410 if the first gate valve 122 is closed. Similarly, the third communication signal 464 tells the subroutine 410 if the second gate valve 128 is open, whereas the fourth communication signal 466 tells the subroutine 410 if the second gate valve 128 is closed. The vacuum sensor is positioned proximate the inlet of the first gate valve 122 and communication signals 468 to the second subroutine 410 indicating whether a vacuum (or reduced pressure exists) is being pulled by the airlock 124. In addition to receiving signals from the sensors, the subroutine 410 is also operative to communicate command signals 470, 472, 474, 476 that open and close the respective gate valves 122, 128. Specifically, the first command signal 470 is operative to open the first gate valve 122, whereas the second command signal 472 is operative to close the first gate valve 122. Similarly, the third command signal 474 is operative to open the second gate valve 128, whereas the fourth command signal 476 is operative to close the second gate valve 128. Whenever a command signal is sent by the second subroutine 410, the master controller 170 is informed that such a command has been sent, as well as a status whether the gate valves 122, 128 are open or closed.

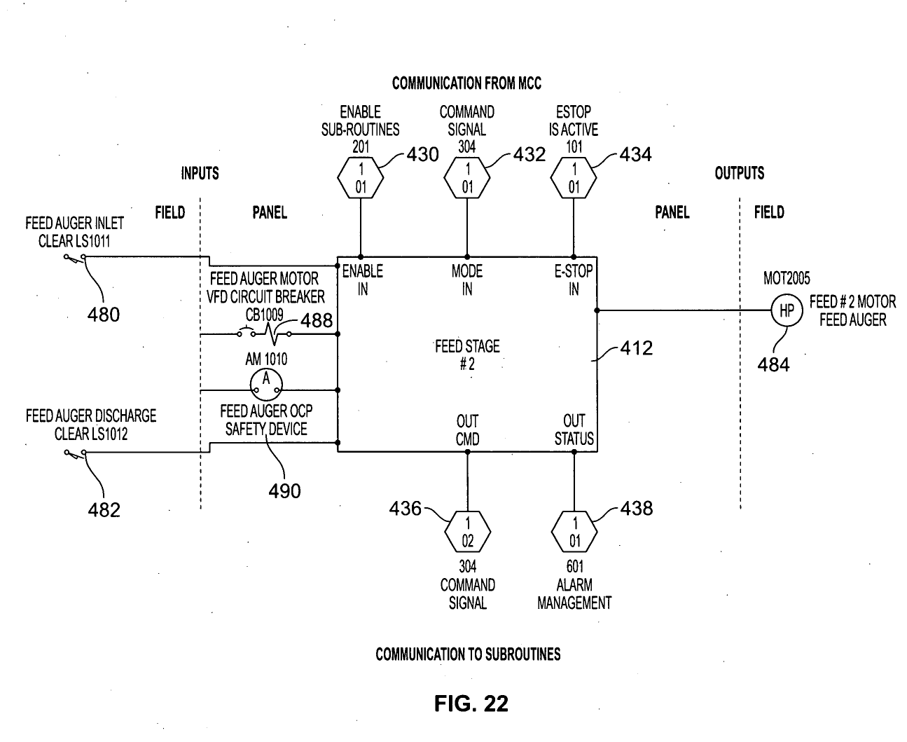

Referencing FIGS. 2 and 22, the third subroutine 412 controls the hardware utilized to bring the feedstock 108 into the pyrolytic reactor 102. The third subroutine 412 receives communication signals 480, 482 from sensors (not shown) associated with the shaft-less auger 126, as well as communicates command signals 484 to the motor 132 turning the shaft-less auger. The first communication signal 480 tells the subroutine 412 if the feed inlet to the shaft-less auger 126 is clear, whereas the second communication signal 482 tells the subroutine if the outlet of the shaft-less auger is clear. Command signals 484 from the subroutine 412 are operative to control the motor 132 operatively coupled to the shaft-less auger. If the communication signals 480, 482 indicate that either inlet or outlet of the shaft-less auger 126 is blocked, the subroutine will not allow the motor 132 to turn the shaft-less auger. Similarly, the third subroutine 412 controls the speed of the motor 132, thereby controlling how much feedstock 108 is delivered to the pyrolysis reactor 102. Finally, this subroutine 412 also includes an associated circuit breaker 488 and a current monitor 490.

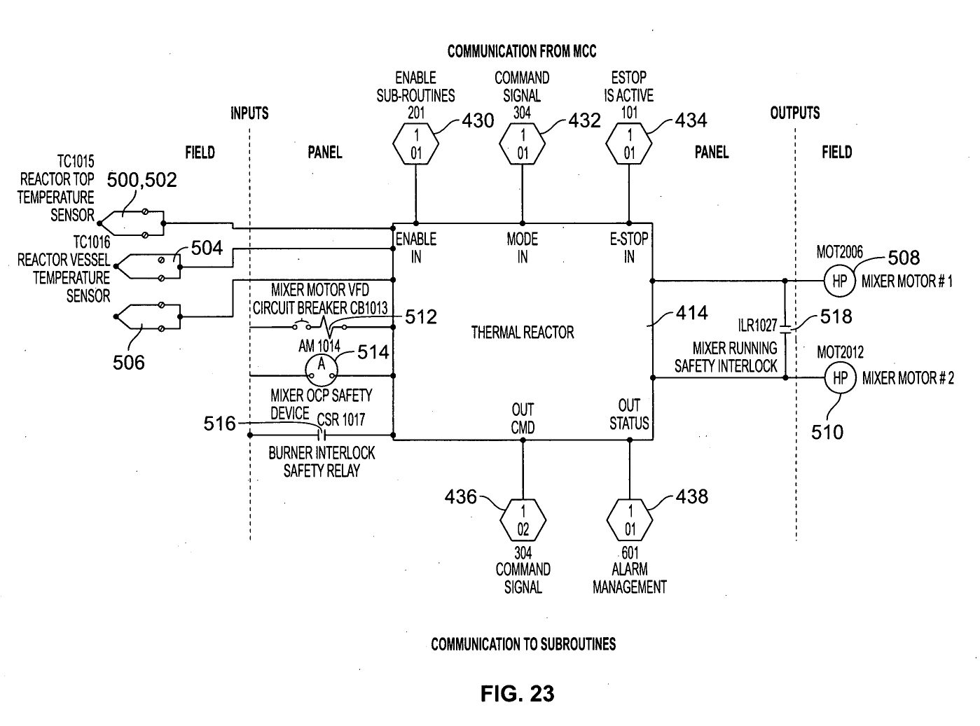

Referring to FIGS. 2 and 23, the fourth subroutine 414 controls the hardware of the pyrolytic reactor 102. The fourth subroutine 414 receives communication signals 500, 502 from temperature sensors (not shown) associated with the interior and exterior of the pyrolytic reactor 102, communication signals 504 from a gas flow rate sensor (not shown), and communication signals 506 from char composition sensors (not shown) at the solids outlet 200 of the pyrolytic reactor 102, as well as command signals 508, 510 to the motors 164, 166 turning the augers 150, 152. The first communication signal 500 tells the subroutine 414 what the temperature one the exterior of the reactor 102 is, whereas the second communication signal 502 tells the subroutine what the internal temperature is within the reactor. For purposes of control illustration only, a single external temperature sensor (not shown) and a single internal temperature sensor (not shown) are discussed herein. Those skilled in the art will readily understand that multiple exterior and interior temperature sensors may be utilized and communicate with the fourth subroutine 414. In fact, multiple temperature sensors are distributed along the length of each cylindrical housing 154. The third communication signal 504 tells the subroutine 414 the flow rate the gases leaving the pyrolytic reactor 102, whereas the fourth communication signal 506 tells the subroutine what composition of the char is exiting the pyrolytic reactor. Command signals 508, 510 from the subroutine 414 are operative to control the motors 164, 166 operatively coupled to the augers 150, 152. If the communication signals 500, 502 indicate that either interior or exterior temperatures of the reactor 102 are outside of an accepted boundary, the burners 106 or other heat source (e.g., combustion exhaust from electricity generation) may be adjusted to bring the temperature back within the accepted boundary. By way of example, if the flow rate of gases is low and the char exiting the pyrolytic reactor 102 is adequately decomposed, the subroutine may take corrective action by increasing the speed of the motors 164, 166. Similarly, the fourth subroutine 414 controls the speed of the motors 164, 166, thereby controlling how quickly the feedstock 108 is conveyed through the pyrolysis reactor 102. For instance, presuming the second motor 166 is not operational (and the second auger 152 is not turning), the subroutine 414 will instruct the first motor 164 to discontinue turning the first auger 150 until the problem with the second motor is resolved. Likewise, if the char exiting the pyrolytic reactor 102 is not sufficiently decomposed, the motors 164, 166 may be increased until the char exiting the reactor is decomposed to just right. Finally, this subroutine 414 also includes an associated circuit breaker 512 and a current monitor 514, in addition to a burner 106 safety relay 516 and an auger 150, 152 safety relay 518.

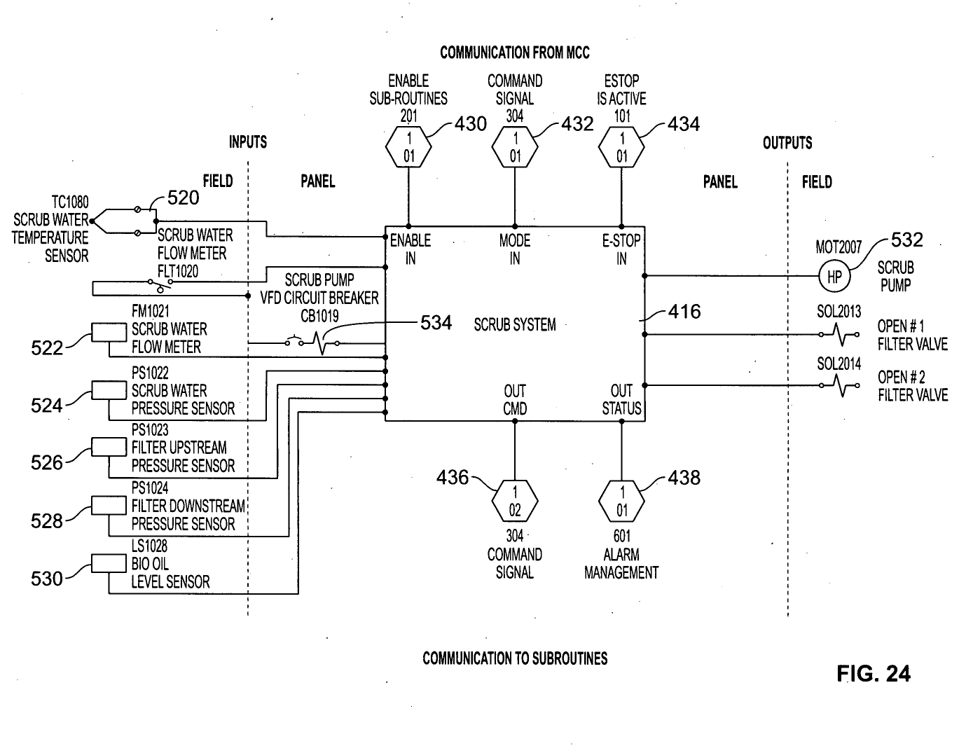

Referencing FIGS. 2 and 24, the fifth subroutine 416 controls the hardware associated with the scrubber 210. The fifth subroutine 416 receives communication signals 520 from a scrubbing water temperature sensor (not shown), communication signals 522 from a scrubbing water level sensor (not shown), communication signals 524 from a scrubbing water flow rate sensor (not shown), communication signals 526 from a scrubbing water pressure sensor (not shown), communication signals 528 from an upstream filter pressure sensor (not shown), and communication signals 530 from a downstream filter pressure sensor (not shown), in addition to command signals 532 to control the scrubbing water pump (not shown). The first communication signal 520 tells the subroutine 416 what the temperature of the scrubbing water is after exiting the heat exchanger 266, whereas the second communication signal 522 tells the subroutine the level of water within the scrubber 210. Likewise, the third communication signal 524 tells the subroutine 416 what the flow rate of the scrubbing water is on the inlet side of the scrubber 210, whereas the fourth communication signal 526 tells the subroutine the pressure of the scrubbing water is on the inlet side of the scrubber 210. Further, the fifth communication signal 528 tells the subroutine 416 what the pressure of the scrubbing water is on the inlet side of the filter(s) 262, whereas the sixth communication signal 530 tells the subroutine the pressure of the scrubbing water is on the outlet side of the filter(s) 262. Finally, the first command signals 532 control the scrubbing water pump that delivers pressurized water to the inlet of the scrubber 210. If the communication signals 520 from the scrubbing water temperature sensor indicate that the scrubbing water is too warm, the subroutine 416 will communicate with another subroutine to increase the heat transfer from the scrubbing water stream flowing within the heat exchanger 266. Conversely, if the communication signals 520 from the scrubbing water temperature sensor indicate that the scrubbing water is too cool, the subroutine 416 will communicate with another subroutine to decrease the heat transfer from the scrubbing water stream flowing within the heat exchanger 266. If the communication signals 522 from a scrubbing water level sensor indicate the water level is too high within the scrubber, the routine 416 will modify the operation of the scrubbing water pump to reduce the water level to an acceptable level. If the communication signals 524 from a scrubbing water flow rate sensor indicate not enough water is being pumped to the scrubber 210, the routine 416 will modify the operation of the water cycle pump 260 and/or scrubbing water pump to increase the water pressure on the inlet side of the scrubber. If the communication signals 528 from an upstream filter pressure sensor indicate a reduced water pressure, the routine 416 will modify the operation of the water cycle pump 260 to increase the water pressure on the inlet side of the filter(s) 262. Conversely, if the communication signals 528 from an upstream filter pressure sensor indicate an increased water pressure, the routine 416 will modify the operation of the water cycle pump 260 to decrease the water pressure on the inlet side of the filter(s) 262. If the communication signals 530 from a downstream filter pressure sensor indicate a reduced pressure, the routine 416 will modify the flow rate of water through the filters 262 to reduce the flow through a partially clogged filter and increase the flow through a lesser clogged filter. Finally, this subroutine 416 also includes an associated circuit breaker 534.

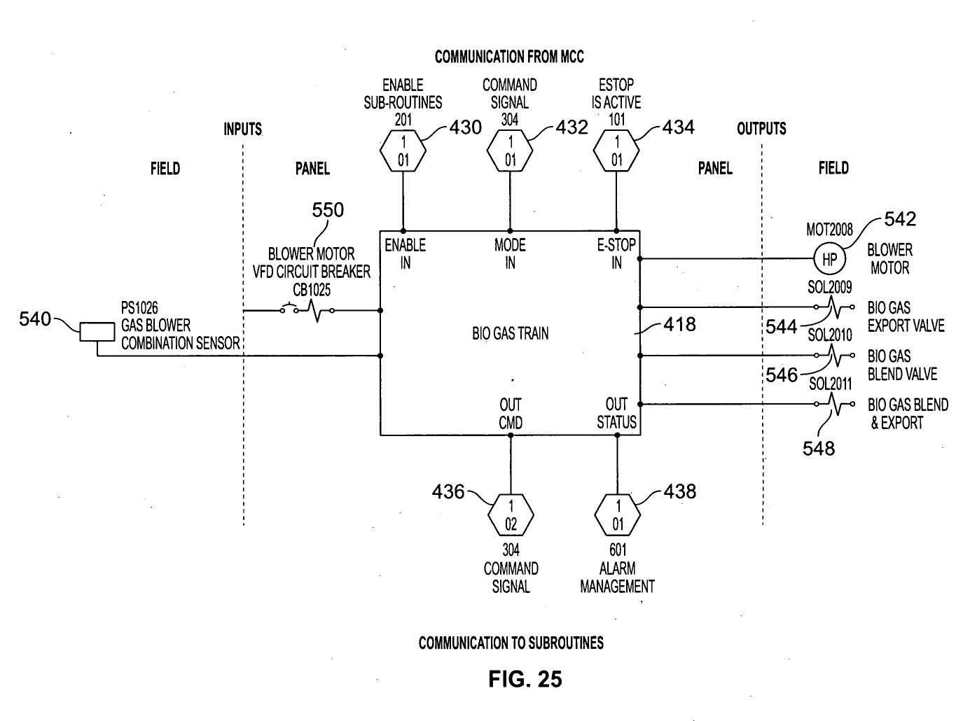

Referencing FIGS. 2 and 25, the sixth subroutine 418 controls to the hardware associated with directing the pyrogas/snygas to a storage tank, direct use, or into an existing pipeline. The sixth subroutine 418 receives communication signals 540 from a pressure sensor/vacuum sensor (not shown) upstream from the make-up blower 300, in addition to command signals 542 to control the make-up blower, command signals 544 to control a pyrogas/snygas export valve 302A, command signals 546 to control a blend valve 302B, and command signals 548 to control an export valve 302C. If the communication signals 540 from the pressure sensor/vacuum sensor indicate the pressure is negative, the routine 416 will continue operation of the make-up blower 300 and leave open one or more of the valves 302A, 302B, 302C. Conversely, if the communication signals 540 from the pressure sensor/vacuum sensor indicate the pressure is not negative or low enough, the routine 416 will increase the rate of the make-up blower 300 and leave open one or more of the valves 302A, 302B, 302C. If, after a predetermined time when the rate of the make-up blower has been increased, the routine 416 discontinue operation of the make-up blower 300 and close one or more of the valves 302A, 302B, 302C. Depending upon the amount of pyrogas/snygas produced by the pyrolytic process 100, the routine 418 may open or close any of the valves 302A, 302B, 302C. For example, presuming the pyrolytic process 100 is not yet producing enough pyrogas/snygas to supply all of the gas for the burners 106, the routine 418 would open the blend valve 302B in order to flow natural gas to make up the deficiency and thus supply all of the gas for the burners 106. Presuming the pyrolytic process 100 is producing enough pyrogas/snygas to supply all of the gas for the burners 106, the routine 418 would open the pyrogas/snygas export valve 302A to direct excess pyrogas/syngas into a storage container or a utility gas supply line/grid. Presuming the pyrolytic process 100 is producing enough pyrogas/snygas to supply all of the gas for the burners 106, the routine 418 would open the pyrogas/snygas export valve 302C to direct excess pyrogas/syngas into a combustion engine 296 operatively coupled to an electric generator 292. In this manner, excess pyrogas/snygas is also utilized to meet the electric requirements of the pyrolytic process 100. Finally, this subroutine 418 also includes an associated circuit breaker 550.

While the foregoing exemplary embodiment and process 100 has been explained to comprise four stages, it should be understood that the number of stages is not magical and rather is only an arbitrary to break up a continuous process, when in fact the pyrolysis reactor could be viewed as having one stage—pyrolysis—or could be viewed to having an infinite number of stages as the pyrolysis reactions continue occurs along the length of the reactor.

Likewise, while the foregoing exemplary embodiment has been explained to comprise two screws 150 152, it should be understood that one or more than two screws may be utilized.

Similarly, while the foregoing exemplary embodiment has been explained as a continuous pyrolysis process, it is also within the scope of the invention to carry out batch pyrolysis reactions.

Each of the organic outputs from the reactor (gas, oil, and solids) is combustible. These combustibles have differing BTU values depending upon the organic feed stream 108 composition. In exemplary form, for each pound (lb) of digested sewage sludge, the combustible gases produced are 1.27 ft³, with a combustible value of 710 BTU/ft³. Similarly, for each pound (lb) of undigested sewage sludge, the combustible gases produced are 2.10 ft³, with a combustible value of 1050 BTU/ft³. Moreover, for each pound (lb) of algae sewage sludge, the combustible gases produced are 2.50 ft³, with a combustible value of 650 BTU/ft³. But the exemplary pyrolytic process may be applied to more than just sewage sludge.

For example, automotive recycling includes separation of metals from non-metallic components. The non-metallic residue comprises predominantly organic materials. In exemplary form, when this non-metallic automotive recycling residue was used as the organic feed stream 108, the combustible gases produced for each pound of residue was 1.83 ft³ having a combustible value of 1280 BTU/ft³. And the process also resulted in significant oil and char production. For each pound of automotive recycling residue, 0.38 lbs of oil was generated having a combustible value of 18,000 BTU/lb, and 0.39 lbs of char was generated, which resulted in a 61% weight reduction in solid components.

Following from the above description and invention summaries, it should be apparent to those of ordinary skill in the art that, while the methods and apparatuses herein described constitute exemplary embodiments of the present invention, the invention contained herein is not limited to this precise embodiment and that changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A pyrolysis process comprising:
heating an organic feedstock within a pyrolytic reactor above a predetermined temperature in an environment having a reduced diatomic oxygen content as part of a decomposition reaction;
monitoring at least one of the composition of a combustible gaseous byproduct from the decomposition reaction, the volume of the combustible gaseous byproduct from the decomposition reaction, the composition of a solids byproduct from the decomposition reaction; and
adjusting at least one of an amount of the organic feedstock fed into the pyrolytic reactor and the resident time of the organic feedstock within the pyrolytic reactor at least in part upon information received from the monitoring step.

2. The process of claim 1, further comprising:
collecting an effluent stream of gases from the pyrolytic reactor using a manifold;
directing the effluent stream of gases to a scrubber;
scrubbing the effluent stream.

3. The process of claim 2, wherein:
scrubbing the effluent stream includes wet venture scrubbing with at least one of a hydrocarbon liquid and water.

4. The process of claim 2, further comprising:
scraping an interior of the manifold to remove viscous liquid and solid residue build up; and,
directing the scraped viscous liquid and solid residue to the scrubber.

5. The process of claim 2, further comprising at least one of:
insulating the manifold to reduce thermal loss from the manifold; and,
heating the manifold other than by the effluent stream of gases flowing therethrough.

6. The process of claim 2, wherein:
the act of directing the effluent stream of gases to the scrubber includes having the effluent gases travel less than twenty feet from the reactor to reach the scrubber.

7. The process of claim 2, wherein:
the act of directing the effluent stream of gases to the scrubber includes having the effluent gases travel less than ten feet from the reactor to reach the scrubber.

8. The process of claim 2, further comprising:
separating an output stream from the scrubber into a gas phase and a liquid phase;
separating the liquid phase into a polar liquid phase and a non-polar liquid phase.

9. The process of claim 8, wherein:
the act of separating the output stream from the scrubber into the gas phase and the liquid phase includes utilizing a separation tank; and
the act of separating the liquid phase into the polar liquid phase and the non-polar liquid phase includes utilizing a separation tank.

10. The process of claim 9, wherein:
the separation tank separating the output stream from the scrubber into the gas phase and the liquid phase is directly downstream from the scrubber;
the separation tank separating the output stream from the scrubber into the polar liquid phase and the non-polar liquid phase is directly downstream from the scrubber; and,
the same separation tank is used to separate the output stream from the scrubber into the vapor phase and the liquid phase, as well as separate the polar liquid phase and the non-polar liquid phase.

11. The process of claim 10, further comprising:
collecting the polar liquid phase within the same separation tank;
discharging the collected polar liquid phase from the same separation tank; and
directing the collected polar liquid phase to a filter in fluid communication with the scrubber.

12. The process of claim 10, further comprising:
collecting the non-polar liquid phase within the same separation tank;
discharging the collected non-polar liquid phase from the same separation tank; and
directing the collected non-polar liquid phase to a holding tank.

13. The process of claim 10, further comprising:
collecting the non-polar liquid phase within the same separation tank;
discharging the collected non-polar liquid phase from the same separation tank; and
directing the collected non-polar liquid phase to a combustion engine.

14. The process of claim 13, further comprising:
combusting at least a portion of the non-polar liquid phase within the combustion engine; and
generating electricity as a by-product of the combustion within the combustion engine.

15. The process of claim 14, wherein:
the combustion engine is operatively coupled to an electric generator; and,
the electric generator is operative to generate the electricity as a by-product of the combustion within the combustion engine.

16. The process of claim 14, further comprising directing an exhaust from the combustion of the non-polar liquid phase to heat the organic feedstock within the pyrolytic reactor.

17. The process of claim 10, further comprising bubbling the gas phase through the liquid phase within the same separation tank.

18. The process of claim 10, further comprising:
collecting the gas phase within the same separation tank; and,
discharging the collected gas phase from the same separation tank.

19. The process of claim 18, wherein:
the discharged gas phase is directed to at least one of a storage tank, a combustion engine, and a pyrolytic reactor burner.

20. The process of claim 19, wherein:
the discharged gas phase is directed to the combustion engine; and
the combustion engine is operatively coupled to a generator.

21. The process of claim 20, further comprising:
combusting at least a portion of the gas phase directed to the combustion engine; and
generating electricity using the generator coupled to the combustion engine.

22. The process of claim 21, further comprising directing an exhaust from the combustion of the gas phase to heat the organic feedstock within the pyrolytic reactor.

23. The process of claim 19, wherein:
the discharged gas phase is directed to the pyrolytic reactor burner; and
the pyrolytic reactor burner is operative to heat the organic feedstock within the pyrolytic reactor.

24. The process of claim 1, further comprising:
discharging solids from the pyrolytic reactor at an exit orifice; and
sealing the exit orifice with a liquid lock that allows the solids to passthrough.

25. The process of claim 24, wherein:
the liquid lock comprises a liquid bath; and
the exit orifice from the pyrolytic reactor is submerged within the liquid bath.

26. The process of claim 25, wherein:
the liquid bath comprises water; and
the liquid bath is housed within a collection container that includes the water and the solids discharged from the pyrolytic reactor.

27. The process of claim 1, further comprising:
monitoring at least one of an internal temperature within the pyrolytic reactor and an external temperature on an exterior of the pyrolytic reactor; and
adjusting how much heat is supplied to the pyrolytic reactor responsive to the monitoring at least one of the internal temperature and the exterior temperature.

27. The process of claim 1, further comprising:
monitoring at least one of an internal temperature within the pyrolytic reactor and an external temperature on an exterior of the pyrolytic reactor; and
adjusting how much heat is supplied to the pyrolytic reactor responsive to the monitoring at least one of the internal temperature and the exterior temperature.

28. The process of claim 1, further comprising:
implementing an airlock upstream from the pyrolytic reactor through which the organic feedstock flows therethrough; and,
monitoring a pressure proximate the airlock to verify the operation of the airlock.

29. The process of claim 1, further comprising:
monitoring a manually actuated safety device upstream from the pyrolytic reactor; and,
operating the pyrolytic reactor only after confirming the manually actuated safety device has not been activated.

30. The process of claim 1, further comprising:
monitoring a hopper adapted to contact at least a portion of the organic feedstock; and,
operating a feeding device to deliver organic feedstock from the hopper to the pyrolytic reactor based upon monitoring the hopper and confirming sufficient organic feedstock is within the hopper.

31. The process of claim 1, wherein:
adjusting the resident time of the organic feedstock within the pyrolytic reactor includes adjusting a rate of rotation of at least one internal auger.

32. The process of claim 1, wherein adjusting the resident time of the organic feedstock within the pyrolytic reactor includes adjusting a rate of rotation for a first auger and a rate of rotation of a second auger.

33. The process of claim 32, wherein the rate of rotation for the first auger is different than the rate of rotation of the second auger.

34. The process of claim 1, further comprising:
scrubbing the combustible gaseous byproduct downstream from the pyrolytic reactor using a wet scrubber;
monitoring at least one of scrubbing fluid temperature at an inlet of the scrubber, scrubbing fluid pressure at the inlet of the scrubber, scrubbing fluid level within the scrubber, and scrubbing fluid flow rate at the inlet of the scrubber;
automatically taking corrective action to modify at least one of scrubbing fluid temperature at an inlet of the scrubber, scrubbing fluid pressure at the inlet of the scrubber, scrubbing fluid level within the scrubber, and scrubbing fluid flow rate at the inlet of the scrubber when one or more of the foregoing are outside of an acceptable range.

35. The process of claim 1, further comprising:
wet scrubbing the combustible gaseous byproduct downstream from the pyrolytic reactor using a wet scrubber;
capturing a wet scrubber fluid after wet scrubbing;
filtering the captured wet scrubber fluid;
directing the filtered wet scrubber fluid to an inlet of the scrubber.

36. The process of claim 35, further comprising:
monitoring at least one of an upstream pressure and a downstream pressure with respect to a filter used to filter the captured wet scrubber fluid; and
changing the filter based upon changes in at least one of an upstream pressure and a downstream pressure over time.

37. The process of claim 35, further comprising:
flowing the filtered wet scrubber fluid through a heat exchanger to change the temperature of the wet scrubber fluid prior to directing the filtered wet scrubber fluid to the inlet of the scrubber;
monitoring a downstream temperature of the filtered wet scrubber fluid with respect to the heat exchanger; and
changing an amount of heat transferred with respect to the filtered wet scrubber fluid based upon monitoring the downstream temperature over time.

38. The process of claim 1, further comprising:
monitoring an amount of the combustible gaseous byproduct produced from the decomposition reaction; and
adjusting control valves to direct the combustible gaseous byproducts to at least one of a holding tank, a combustion engine, and a combustible gas pipeline.

39. The process of claim 1, further comprising:
combusting at least a portion of the combustible gaseous byproduct produced from the decomposition reaction; and
directing the exhaust from combusting at least a portion of the combustible gaseous byproduct into thermal communication with the pyrolytic reactor.

40. A pyrolysis system comprising:
a continuous process pyrolysis reactor including a variable speed conveyor;
a manifold in fluid communication with the pyrolysis reactor to collect effluent gases from a pyrolysis reaction occurring within the pyrolysis reactor;
at least one of an effluent gas sensor monitoring the effluent gases from the pyrolysis reactor, an effluent gas volume sensor monitoring a volume of the effluent gases from the pyrolysis reactor, and a solids byproduct sensor monitoring a solids byproduct from the pyrolysis reactor; and,
a controller for controlling the speed of the conveyor responsive to signals from at least one of the effluent gas sensor, the effluent gas volume sensor, and the solids byproduct sensor.

41. A pyrolysis system of claim 40, further comprising an automated mechanical scraper housed within the manifold to remove viscous liquids and solids accumulating in the manifold.

42. A pyrolysis system of claim 40, further comprising a scrubber in fluid communication with the manifold and receiving effluent gases, viscous liquids, and solids from the manifold.

43. The pyrolysis system of claim 42, wherein the scrubber is a venturi wet scrubber.

44. The pyrolysis system of claim 43, wherein the venturi wet scrubber is a direct scrubber using a hydrocarbon liquid as the scrubbing fluid.

45. The pyrolysis system of claim 43, wherein the venturi wet scrubber is a direct scrubber using water as the scrubbing fluid.

46. The pyrolysis system of claim 40, further comprising insulation at least partially housing the manifold.

47. The pyrolysis system of claim 42, wherein the scrubber is within twenty feet of the pyrolytic reactor.

48. The pyrolysis system of claim 42, wherein the scrubber is within ten feet of the pyrolytic reactor.

49. The pyrolysis system of claim 42, wherein the scrubber is within twenty feet of the manifold.

50. The pyrolysis system of claim 42, wherein the scrubber is within ten feet of the manifold.

51. The pyrolysis system of claim 40, further comprising a separation tank downstream from the scrubber.

52. The pyrolysis system of claim 51, wherein the separation tank receives a direct output from the scrubber.

53. The pyrolysis system of claim 51, wherein the separation tank includes:
a gaseous outlet orifice;
a liquid outlet orifice; and
an inlet orifice.

54. The pyrolysis system of claim 53, further comprising a holding tank downstream from the liquid outlet orifice for storing a liquid exiting the liquid outlet orifice of the separation tank.

55. The pyrolysis system of claim 53, further comprising:
a scrubber in fluid communication with the manifold and receiving effluent gases, viscous liquids, and solids from the manifold;
a filter downstream from the separation tank for cleaning a liquid exiting the liquid outlet orifice of the separation tank; and,
a fluid exit stream from the filter feeds comprises the scrubbing fluid fed to the scrubber.

56. The pyrolysis system of claim 55, wherein the scrubber is a venturi wet scrubber.

57. The pyrolysis system of claim 56, wherein the scrubbing fluid is at least one of polar and non-polar.

58. The pyrolysis system of claim 56, wherein the scrubbing fluid is at least one of water and a hydrocarbon liquid.

59. The pyrolysis system of claim 40, further comprising insulation insulating the manifold.

60. The pyrolysis system of claim 40, further comprising:
a combustion engine downstream from the pyrolysis reactor; and,
wherein the combustion engine combusts at least a portion of the effluent gases from the pyrolysis reactor.

61. The pyrolysis system of claim 60, wherein:
at least a portion of the effluent gases from the pyrolysis reactor comprise a liquid hydrocarbon fuel;
the combustion engine combusts the liquid hydrocarbon fuel; and,
the combustion engine is operatively coupled to an electric generator.

62. The pyrolysis system of claim 61, wherein an exhaust from the combustion engine is in thermal communication with the pyrolysis reactor.

63. The pyrolysis system of claim 60, wherein:
at least a portion of the effluent gases from the pyrolysis reactor comprise a gaseous hydrocarbon fuel;
the combustion engine combusts the gaseous hydrocarbon fuel; and,
the combustion engine is operatively coupled to an electric generator.

64. The pyrolysis system of claim 63, wherein an exhaust from the combustion engine is in thermal communication with the pyrolysis reactor.

65. The pyrolysis system of claim 40, wherein:
the pyrolysis reactor includes a cylindrical housing at least partially surrounding the conveyor;
an interior of the housing includes at least three flights that provide contact surfaces against which the conveyor contacts; and,
the conveyor includes an auger.

66. The pyrolysis system of claim 65, wherein the cylindrical housing is rotatably repositionable.

67. The pyrolysis system of claim 40, further comprising:
a solids exit orifice associated with the pyrolytic reactor; and,
a liquid lock to seal the solids exit orifice and allow solids to exit the pyrolytic reactor at the solids exit orifice.

68. The pyrolysis system of claim 67, wherein:
the liquid lock comprises a liquid bath; and,
the solids exit orifice from the pyrolytic reactor is submerged within the liquid bath.

69. The process of claim 68, wherein:
the liquid bath comprises water; and,
the liquid bath is housed within a collection container that includes the water and the solids discharged from the pyrolytic reactor.

70. The pyrolysis system of claim 40, further comprising:
a master controller; and
a plurality of subroutines communicating with the master controller and receiving commands from the master controller;
wherein the controller for controlling the speed of the conveyor responsive to signals from at least one of the effluent gas sensor, the effluent gas volume sensor, and the solids byproduct sensor comprises one of the plurality of subroutines.

71. The pyrolysis system of claim 70, wherein at least one of the plurality of subroutines comprises a controller for controlling an airlock upstream from the pyrolysis reactor.

72. The pyrolysis system of claim 70, wherein at least one of the plurality of subroutines comprises a controller for controlling a feeder delivering organic feedstock into the pyrolysis reactor.

73. The pyrolysis system of claim 70, wherein the conveyor comprises at least one auger housed within at least one longitudinal tube.

74. The pyrolysis system of claim 73, wherein:
the at least one auger housed within at least one longitudinal tube comprises a first auger housed within a first longitudinal tube and a second auger housed within a second longitudinal tube;
the first auger is operatively coupled to a first motor;
the second auger is operatively coupled to a second motor; and
the controller independently controls the first motor and the second motor.

75. The pyrolysis system of claim 70, wherein at least one of the plurality of subroutines comprises a controller for controlling a scrubber downstream from the pyrolysis reactor.

76. The pyrolysis system of claim 70, wherein at least one of the plurality of subroutines comprises a controller for controlling at least one valve downstream from a scrubber that is downstream from the pyrolysis reactor.

77. A pyrolysis system comprising:
a continuous process pyrolysis reactor including a variable speed conveyor;
a manifold in fluid communication with the pyrolysis reactor to collect effluent gases from a pyrolysis reaction occurring within the pyrolysis reactor;
a controller for controlling the speed of the conveyor responsive to a rate of decomposition occurring within the pyrolysis reactor;
a combustion engine combusting at least a portion of the effluent gases from the pyrolysis reactor; and
an electric generator operatively coupled to the combustion engine for generating electricity.

78. A method of carrying out a pyrolysis reaction and generating electricity, the process comprising:
decomposing a feedstock including an organic constituent within a continuous process pyrolysis reactor to generate effluent gases;
pulling the effluent gases away from the pyrolysis reactor;
combusting at least a portion of the effluent gases pulled away from the pyrolysis reactor; and
generating electricity operatively coupled to the combustion engine for generating electricity.

79. A pyrolysis system comprising:
a pyrolysis reactor;
a collection duct to collect effluent gases from a pyrolysis reaction occurring within the pyrolysis reactor;
a combustion engine combusting at least a portion of the effluent gases from the pyrolysis reactor;
an electric generator operatively coupled to the combustion engine for generating electricity; and,
a duct for directing exhaust from the combustion engine into thermal communication with the pyrolysis reactor to further the pyrolysis reaction.

80. A method of carrying out a pyrolysis reaction and generating electricity, the process comprising:
decomposing a feedstock including an organic constituent within a pyrolysis reactor to generate effluent gases;
directing the effluent gases away from the pyrolysis reactor;
combusting at least a portion of the effluent gases pulled away from the pyrolysis reactor;
generating electricity operatively coupled to the combustion engine for generating electricity; and
directing exhaust from the combusting step into thermal communication with the pyrolysis reactor to further the decomposition step.
